(19) United States
(12) Patent Application Publication
(10) Pub. No.: US 2011/0155106 A1
(43) Pub. Date: Jun. 30, 2011

(54) INTERNAL COMBUSTION ENGINE WITH VARIABLE COMPRESSION RATIO

(76) Inventor: Michael von Mayenburg, Villach-Landskron (AT)

(21) Appl. No.: 12/964,369

(22) Filed: Dec. 9, 2010

Related U.S. Application Data
(63) Continuation-in-part of application No. 12/901,434, filed on Oct. 8, 2010.
(60) Provisional application No. 61/405,612, filed on Oct. 21, 2010.
(60) Provisional application No. 61/388,906, filed on Oct. 1, 2010.
(60) Provisional application No. 61/290,682, filed on Dec. 29, 2009.

(51) Int. Cl. F02B 75/04

(52) U.S. Cl. 123/48 B

(57) ABSTRACT

In one form of variable compression ratio engine, a connecting rod of an internal combustion engine is coupled to the rod receiving crank shaft by an eccentric connecting rod bearing. Pivoting of an eccentric portion of the eccentric connecting rod bearing relative to the crank shaft pin by a compression ratio adjuster varies the compression ratio of the engine. Resistance is provided to the pivoting of the eccentric portion in the absence of a compression ratio adjustment force. Pivoting of the eccentric can be delayed until tension and compression forces in the connecting rod are at a reduced level. The compression ratio can be continuously varied over a range from low to high values within limits of the structural components of the system to allow greater control of the compression ratio.

### CROSS-REFERENCE TO RELATED APPLICATIONS

This application is a continuation-in-part of U.S. patent application Ser. No. 12/901,434, titled INTERNAL COMBUSTION ENGINE WITH VARIABLE COMPRESSION RATIO, filed Oct. 8, 2010, and this application claims the benefit of U.S. Provisional Application No. 61/405,612, filed on Oct. 21, 2010, titled INTERNAL COMBUSTION ENGINE WITH VARIABLE COMPRESSION RATIO, and claims the benefit of U.S. Provisional Application No. 61/388,906, titled INTERNAL COMBUSTION ENGINE WITH VARIABLE COMPRESSION RATIO, filed on Oct. 1, 2010, and claims the benefit of U.S. Provisional Application No. 61/290,682, titled “Internal Combustion Engine with Variable Compression Ratio”, filed Dec. 29, 2009.

### FIELD

The technology disclosed herein relates to methods and apparatus for adjusting the compression ratio of an internal combustion engine, such as for gasoline and diesel fueled engines. More specifically, the technology relates to engines in which respective eccentric connecting rod bearings couple the one or more connecting rods of an engine to an engine crank shaft and wherein pivoting of the eccentric portions of the eccentric connecting rod bearings adjusts the compression ratio.

### BACKGROUND

Gasoline fueled engines are typically designed so that under full load (open throttle) no uncontrolled combustion (knocking) occurs that limits the compression ratio. Under throttled conditions, the gasoline engine is under-compressed, which can reduce engine efficiency. Diesel fueled engines are typically over compressed to enhance starting in cold conditions. Diesel engines that have warmed up would be more efficient if they had a lower compression ratio. Thus, a variable compression ratio engine can be operated under various operating conditions to vary the engine compression so as to, for example, increase engine efficiency. A need exists for an improved variable compression ratio engine and related methods.

### SUMMARY

In accordance with one embodiment of this disclosure, the one or more connecting rods of an internal combustion engine are coupled to an associated rod receiving crank shaft pin or connecting rod coupling portion of a crank shaft by an eccentric connecting rod bearing assembly. Pivoting of an eccentric portion of each eccentric connecting rod bearing relative to the associated crank shaft pin varies the compression ratio of the engine. In accordance with this embodiment, a relatively mechanically simple and efficient mechanism is provided for pivoting the eccentric portion in response to the application of a compression adjustment force. In accordance with another aspect of this embodiment, resistance is provided against pivoting of the eccentric portion of the eccentric connecting rod bearing in the absence of the application of a compression ratio adjustment force so that torque forces arising during the operation of the engine do not spontaneously turn the eccentric portion. Such forces can arise, for example, from the bearing friction torque and eccentricity torque due to the use of a connecting rod bearing with an eccentric portion. As another aspect of this embodiment, pivoting of the eccentric portion can be delayed until tension and compression forces in the associated connecting rod are at a reduced level.

In one specific approach, the position of a compression ratio adjuster is moved to load an energy storer, which can comprise one or more springs, with potential energy that is applied to the eccentric crank shaft bearing. As the associated piston approaches or reaches one or more positions where compression and tension forces in the connecting rod are insufficient to resist pivoting of the eccentric portion of the crank shaft bearing by the stored potential energy, the eccentric portion is pivoted by the stored potential energy to thereby vary the compression ratio.

In accordance with an aspect of any of the one or more of the embodiments disclosed herein, the compression ratio (epsilon) can be continuously varied over a range between low to high values within limits of the structural components of the system to allow greater control of the compression ratio. For example, the compression ratio epsilon of a diesel engine can be relatively high for good cold starting characteristics of the diesel engine and relatively low when the engine is warm. In one specific example, it is desirable for a diesel engine to have an epsilon value ranging from 17.5 during cold starting conditions to 14.5 when the engine is warm. In connection with a gasoline engine, it is desirable to have a relatively low compression ratio to avoid misfiring (knocking) at high engine loads, with a high compression ratio being more efficient at low engine loads. In one specific example, a turbocharged gasoline engine desirably can have a compression ratio or epsilon range from 8 to 14 for efficiency purposes. By adjusting the compression ratio, the firing pressure of diesel engines, which is about 200 bar with new engine designs, can be adjusted to a range that is close to 140 bar. A firing pressure close to 140 bar is close to the firing pressure seen in turbocharged gasoline internal combustion engines today. As a result, the designs of diesel and gasoline engines can be harmonized to have similar firing pressures at least under certain operating conditions.

In accordance with an exemplary embodiment, an internal combustion engine comprises: a crank shaft rotatable about a crank shaft axis, the crank shaft comprising a connecting rod coupling portion defining a first axis; at least one piston cylinder; a piston slidably received by said at least one cylinder so as to reciprocate between top dead center and bottom dead center positions within said cylinder; and a connecting rod comprising a piston coupling end portion pivotally coupled to the piston and a crank coupling end portion pivotally coupled to the connecting rod coupling portion of the crank shaft such that rotation of the crank shaft causes the connecting rod to reciprocate and move the piston between top dead center and bottom dead center positions. As an aspect of this embodiment, a crank shaft coupler is included and comprises an eccentric portion defining a second axis and operable to couple the connecting rod coupling portion of the crank shaft to the crank coupling end portion of the connecting rod, the eccentric portion being positioned such that pivoting of the crank shaft coupler about the first axis from a first crank shaft coupler position to a second crank shaft coupler position pivots the eccentric portion from a first eccentric position to a second eccentric position and shifts the second axis relative to the crank shaft axis to thereby vary the compression ratio of said at least one piston cylinder. As another aspect of this embodiment, a compression ratio adjuster is included and comprises a first portion such as a drive member coupled to the crank shaft coupler and pivotable from a first compression ratio adjuster position to a second compression ratio adjuster position in response to a compression ratio adjustment force, the compression ratio adjuster comprising an energy storage member coupled to the first portion of the compression ratio adjuster and to the crank shaft coupler. As a further aspect of this embodiment, pivotal movement of the first portion of the compression ratio adjuster from the first compression ratio adjuster position to the second compression ratio adjustment position loads the energy storage member with potential energy, the potential energy pivoting the crank shaft coupler eccentric portion from the first crank shaft coupler position to the second crank shaft coupler position as the piston approaches or reaches one or more positions where compression and tension forces in the connecting rod are insufficient to resist pivoting of the crank shaft coupler eccentric portion by the potential energy. As a still further aspect of this embodiment, first and second engagement surfaces are positioned on or between the connecting rod and the first portion of the compression ratio adjuster and in contact with one another, the first and second engagement surfaces being pivotal relative to one another and providing frictional resistance to pivoting of the eccentric portion in the absence of the compression ratio adjustment force.

In accordance with another aspect of any one or more of the preceding embodiments, the internal combustion engine can comprise at least one of (a) the crank shaft coupler being coupled to the connecting rod coupling portion of the crank shaft by first and second engagement surfaces that comprise engaging features that permit pivoting of the crank shaft coupler relative to the connecting rod coupling portion while resisting such relative pivoting; (b) the crank shaft coupler being coupled to the crank coupling end portion of the connecting rod by first and second engagement surfaces that comprise engaging features that permit pivoting of the crank shaft coupler relative to the crank coupling end portion of the connecting rod while resisting such relative pivoting; or (c) the compression ratio adjuster being coupled to the crank shaft by first and second engagement surfaces that comprise engaging features that permit pivoting of the compression ratio adjuster relative to the crank shaft coupler while resisting such relative pivoting.

In accordance with yet another aspect of any one or more of the preceding embodiments, the engaging features can comprise any one or more of the following: interfitting threads; annular interfitting rings; annular grooves; or interfitting substantially V-shaped grooves and interfitting substantially V-shaped ridges, the grooves and ridges having side walls with an angle α there between, and wherein a is selected such that the frictional resistance resulting from such interfitting grooves and ridges is greater than the sum of the eccentricity torque and the bearing friction torque, the bearing friction torque being the torque between the connecting rod and crank shaft coupler and the torque between the crank shaft coupler and the connecting rod coupler.

As a further aspect of any one or more of the preceding embodiments, one of the first and second engagement surfaces can be formed on the connecting rod coupling portion of the crank shaft. Except for fine grinding to provide a smooth surface quality to the engagement surfaces on the coupling rod coupling portion of the crank shaft, the engagement surfaces on the rod coupling portion of the crank shaft can be formed by a process other than by removing material from the crank shaft coupling portion, such as by a pressure rolling or forging process.

As a further aspect of any one or more of the preceding embodiments, the compression ratio adjuster can comprise: a compression adjustment shaft that is pivotal about a compression adjustment shaft axis spaced from and parallel to the crank shaft axis, second and third spaced apart drive members mounted to the compression adjustment shaft, a first drive member coupled to the crank shaft and rotatable relative to the crank shaft, the first drive member being drivenly coupled to the second drive member, a fourth drive member coupled to the crank shaft coupler and drivenly coupled to the third drive member, a compression ratio adjustment force generator, such as a hydro motor or electromagnetic motor, coupled to the first drive member and operable to pivot the first drive member relative to the crank shaft to thereby apply the compression ratio adjuster adjustment force to the first drive member, from the first drive member to the second drive member, from the second drive member to the compression adjustment shaft, from the compression adjustment shaft to the third drive member and from the third drive member to the fourth drive member, wherein the fourth drive member can comprise the first portion of the compression ratio adjuster; the turning of the first and fourth drive members being in the same direction and the turning of the second and third drive members being in the same direction, and the drive ratio of the first drive member to second drive member being the same as the drive ratio of the fourth drive member to the third drive member. The drive members can, for example, be drive gears, chain or belt drive sets, or any combination thereof. In addition, the drive ratio of the first drive member to the second drive member can be at a predetermined ratio, such as at two to one or one to one, and the drive ratio of the fourth drive member to the third drive member can be at the same predetermined ratio, such as two to one or one to one.

In accordance with a still further aspect of any one or more of the preceding embodiments, the compression ratio adjustment force generator can be mounted to the crank shaft and couple the first drive member to the crank shaft or mounted to the compression adjustment shaft. In this latter alternative, the balance shaft can in one embodiment be coaxial with the compression adjustment shaft, and the compression ratio adjustment force generator can connect the balance shaft to the compression adjustment shaft.

As yet another aspect of any one or more of the preceding embodiments, the crank shaft coupler can comprise an eccentric connecting rod bearing comprising a plurality of sections that each define a portion of a bore that receives the connecting rod coupling portion of the crank shaft, the eccentric bearing sections together encircling the connecting rod coupling portion of the crank shaft.

In accordance with an aspect of any one or more of the preceding embodiments, the energy storage member can comprise at least one first biasing spring and at least one second biasing spring associated with one of the drive members, with said at least one first biasing spring being operable such that said at least one first biasing spring is loaded with the potential energy upon pivoting the associated drive member in a first direction, and with said at least one second biasing spring being operable such that said at least one second biasing spring is loaded with potential energy upon pivoting the associated drive member in a second direction opposite to the first direction.

In accordance with a still further aspect of any one or more of the preceding embodiments, the crank shaft coupler can comprise a projecting lever portion that defines a link pin receiving slot, the compression ratio adjuster can comprise a link comprising a base portion and a crank shaft coupler engager, such as a pin, projecting from the base portion, the crank shaft coupler engager pin being slidably and pivotally positioned within said link pin receiving slot, the link comprising first and second arcuate leg portions projecting from the base portion, the first portion of the compression ratio adjuster comprising a drive member comprising a first arcuate recess portion positioned to receive a portion of the first leg portion, the drive member also comprising a second arcuate recess portion positioned to receive a portion of the second leg portion, the energy storage member comprising, at least one first biasing spring being coupled to the first leg portion and positioned in the first recess portion and at least one second biasing spring being coupled to the second leg portion and positioned in the second recess portion, the first and second recess portions each comprising a stop against which the respective at least one first and second biasing springs are compressed upon pivoting the fourth drive member in the respective first and second directions to thereby store potential energy in the respective compressed at least one of said first and second biasing springs, the potential energy pivoting the eccentric portion of the crank coupler when compression forces and tension forces in the connecting rod are insufficient to resist pivoting of the crank shaft coupler eccentric portion.

In accordance with another aspect of any one or more of the preceding embodiments, comprise a first drive member portion pivotal relative to a second drive member portion, at least one biasing spring coupling the first drive member portion to the second drive member portion, and the first drive member portion being pivoted relative to the second drive member portion to store the potential energy in the at least one biasing spring in response to the application of the compression ratio adjuster adjustment force.

In accordance with a further aspect of any one or more of the preceding embodiments, the crank coupling end portion of the connecting rod can comprise a connecting rod bore bounded by a connecting rod bore surface, the crank shaft connecting rod coupling portion can comprise a crank pin portion bounded by an exterior crank pin surface, the crank shaft coupler can comprise a crank pin receiving bore bounded by a crank pin receiving bore surface with the crank pin portion being received by the crank pin receiving bore, the crank shaft coupler can comprise a crank shaft coupler exterior surface with the crank shaft coupler being received by the connecting rod bore. In addition, the engaging features can comprise: (a) features on the exterior crank pin surface and features on the crank pin receiving bore surface; or (b) features on the crank shaft coupler exterior surface and features on the connecting rod bore surface. Alternatively or additionally, the engaging features can comprise features on a crank shaft cheek portion and features on the drive member that engage one another. In addition, selected surfaces can be provided with bearing material with engaged surfaces having a bearing quality.

In accordance with yet another aspect of any one or more of the preceding embodiments, first and second spaced apart seals can be operably positioned to seal access to the engaging features from the exterior of the crank shaft coupler.

In accordance with a further aspect of any one or more of the preceding embodiments, a lubricating fluid distribution cavity can be formed in a crank pin receiving bore surface of the crank shaft coupler and at least one lubricating fluid flow opening can communicate from the crank shaft coupler exterior surface to the lubricating fluid distribution cavity, the lubricating fluid distribution cavity being positioned such that communication is maintained between at least one lubricating fluid flow opening and the lubricating fluid flow distribution cavity in all positions of the eccentric portion of the crank shaft coupler is pivoted.

As another aspect of any one or more of the preceding embodiments, at least one drive member can comprise an annular drive member comprising at least two arcuate sections and the arcuate sections can comprise interfitting locking features that selectively secure the arcuate sections together to comprise the drive member. The drive member can be adapted for mounting or coupling to the crank shaft so as to allow pivoting relative to the crank shaft. For example, the drive member can comprise a threaded annular crank shaft mounting surface that is threadedly mounted to a threaded annular drive member supporting surface. As another alternative example, the drive member can comprise an annular crank shaft mounting surface with an annular retention spring receiving groove, a retention spring ring can be selectively positioned in the retention spring receiving groove of the drive member and in an annular retention spring receiving groove of a drive member supporting surface of the crank shaft to thereby mount the drive member to the crank shaft.

As yet another alternative example, the crank shaft can comprise a drive member support portion, the first portion of the compression ratio adjuster can comprise a drive member adapted for pivotal support by the drive member support portion of the crank shaft, the drive member comprising first and second major opposed drive member surfaces, the first drive member surface generally facing toward an associated crank shaft coupler and the second drive member surface generally facing away from the associated crank shaft coupler, the second drive member surface comprising a wall engaging surface portion, the engine comprising a drive member engaging wall portion with a wall surface positioned to engage the wall engaging portion to restrict shifting of the drive member in an axial direction away from the associated crank shaft coupler. In this latter example, the wall engaging surface portion and the drive member engaging wall portion can each comprise convex engaging surfaces positioned to slidably engage one another.

As a further aspect of any one or more of the preceding embodiments, the crank shaft coupler can comprise an eccentric connecting rod bearing comprising a counter balance member positioned to counter balance the eccentric portion. In addition, as a more specific example, the crank shaft coupler can comprise a lever portion adapted to engage a drive member. The lever portion can comprise a flange that defines a drive slot and a drive member can comprise a projection that slidably engages the slot. In addition, a portion of the flange can comprise the counter balance member.

As yet another aspect of any one or more of the preceding embodiments, a mass balancing weight can be slidably coupled to the crank shaft, a cam can be coupled to a drive member and to the mass balancing weight, and the cam can be configured and positioned such that pivoting the compression ratio adjuster to shift the eccentric portion of the crank shaft coupler pivots the associated drive member and cam in a direction such that the cam shifts the mass balancing weight to counter balance the movement of the eccentric portion of the crank shaft coupler. As a more specific example of this embodiment, the crank shaft can comprise a cheek portion, the associated drive member can be pivotally coupled to the cheek portion, the cheek portion can define a cavity that slidably receives the mass balancing weight so as to permit radially outward and radially inward motion of the mass balancing weight toward and away from the crank shaft axis, the mass balancing weight can comprise a position adjustment projection extending outwardly from the mass balancing weight and into engagement with the cam such that pivoting the cam in one direction shifts the mass balancing weight radially inwardly and pivoting the cam in a direction opposite to said one direction allows the mass balancing weight to shift radially outwardly, and wherein rotation of the crank shaft urges the mass balance weight radially outwardly.

As an aspect of any one or more of the preceding embodiments, an internal combustion engine can comprise a first mass balancing shaft parallel to the axis of rotation of the crank shaft and coaxial with the compression adjustment shaft, the first mass balancing shaft being drivenly coupled to the crank shaft, and a second mass balancing shaft parallel to the axis of rotation of the crank shaft and drivenly coupled to the crank shaft. As alternative examples, the compression adjustment shaft can be positioned at least partially within the first mass balancing shaft, or the first mass balancing shaft can be positioned at least partially within the compression adjustment shaft.

As yet another aspect of any one or more of the preceding embodiments, there can be first and second or more of said piston cylinders; a respective associated first piston slidably received by each of said piston cylinders, a respective connecting rod, crank shaft coupler, third drive member and fourth drive member associated with each piston and coupled to the associated piston, and a common compression adjustment shaft, common first drive member and common second drive member associated with all of the pistons.

In accordance with a still further aspect of any one or more of the preceding embodiments, the compression ratio adjuster can be operated to continuously vary the first and second positions. Although variable, in one specific example, the first and second positions can vary over a predetermined range, such as up to approximately one hundred and forty degrees. A center position of the range can correspond to the crank shaft coupler being pivoted to a position that aligns the first axis and the second axis in a line parallel to the crank shaft axis.

In accordance with an embodiment of a method of adjusting the compression ratio of an internal combustion engine, the method embodiment comprises: rotating a crank shaft coupled to a piston by a connecting rod to reciprocate a piston within a cylinder between a top dead center position and a bottom dead center position; turning an eccentric portion of a crank coupler that couples a crank shaft to the connecting rod to adjust the top dead center and bottom dead center positions to adjust the compression ratio; and storing potential energy in response to turning a compression ratio adjuster; wherein the act of turning the eccentric portion of the crank coupler is performed utilizing the stored potential energy when the piston is in a position away from the bottom dead center portion and to a position wherein the forces on the connecting rod are reduced in comparison to such forces at either of the bottom dead center position or top dead center position.

As another aspect of the method, the act of turning the crank shaft coupler can comprise utilizing the potential energy to turn the crank shaft coupler at times when forces on a connecting rod coupling the piston to a crank shaft approach or reach a transition from compression forces to tension forces or from tension forces to compression forces. In addition, in accordance with one aspect of an embodiment the act of turning the crank shaft coupler can comprise at least partially turning the crank shaft coupler after the piston travels away from the bottom dead center position and before the piston reaches the top dead center position.

As yet another embodiment of a method of coupling a connecting rod to an eccentric portion of a crank shaft coupler, the connecting rod being coupled to a piston that travels in a piston receiving cylinder between top dead center and bottom dead center positions, the piston rod being coupled by the crank shaft coupler to a crank shaft such that when the crank shaft is driven by an internal combustion engine the piston rod reciprocates and moves the piston in the piston cylinder, the method of this embodiment can comprise: pivoting the crank shaft coupler about a longitudinal axis of a connecting rod bore that receives the crank shaft coupler to rotate the eccentric portion of the crank shaft coupler relative to the connecting rod and adjust the compression ratio; and coupling at least one of (a) the crank shaft coupler to the connecting rod coupling portion of the crank shaft by engaging features that permit pivoting of the crank shaft coupler relative to the connecting rod coupling portion while resisting such relative pivoting; (b) the crank shaft coupler to the crank coupling end portion of the connecting rod by engaging features that permit pivoting of the crank shaft coupler relative to the crank coupling end portion of the connecting rod while resisting such pivoting; or (c) the compression ratio adjuster to the crank shaft by engaging features that permit pivoting of the compression ratio adjuster relative to the crank shaft coupler while resisting such relative pivoting.

As yet another aspect of an embodiment of the preceding method, the act of pivoting can comprise storing potential energy and using the potential energy to pivot the crank shaft coupler when tension and compression forces on the connecting rod reach or approach a transition between tension to compression forces or compression to tension forces.

As an embodiment of a crank shaft for coupling to a connecting rod of an internal combustion engine, the crank shaft can comprise: a crank shaft body defining a crank shaft first axis about which the crank shaft is rotatable, the crank shaft comprising at least one crank pin portion for coupling to a connecting rod, the crank pin portion having a second axis parallel to the first axis; the crank pin portion comprising a substantially right cylindrical exterior surface with surface features thereon, the surface features comprising at least one of threads, annular grooves, or annular rings that extend about the second axis. In addition, in an embodiment, the crank shaft pin portion surface features can have substantially V-shaped cross sectional shapes with side walls that diverge from one another by an angle α moving away from the second axis, wherein the angle α can, for example, be about fifty degrees. As a more specific alternative embodiment, the crank pin portion surface features can consist of annular grooves spaced apart along the second axis. The crank pin surface portion in an embodiment can be formed, except for grinding or surfacing of the formed surface features, other than by removing material from the exterior surface to form the surface features, such as by forging or pressure rolling.

Adjustable compression ratio engines as disclosed herein can be operated to improve the efficiency of the engine by varying the compression ratio appropriately.

### BRIEF DESCRIPTION OF THE DRAWINGS

FIG. 1 is a vertical sectional view of an embodiment of an internal combustion engine with one form of compression ratio adjustment mechanism utilizing eccentric connecting rod bearings to selectively vary the compression ratio of the engine.

FIG. 2 is a vertical sectional view of the embodiment of FIG. 1, taken along line 2-2 of FIG. 1.

FIGS. 2A and 2B are respective vertical sectional and side elevational views of an exemplary connecting rod and eccentric connecting rod bearing with a bearing therebetween

FIGS. 3A, 3B and 3C illustrate an eccentric connecting rod bearing in various operating positions, with each position corresponding to a different engine compression ratio, and also showing an embodiment of a potential energy storer.

FIGS. 4, 4A and 4B illustrate one embodiment of a drive member that can be used in the embodiment of FIG. 1 to shift the position of the eccentric connecting rod bearing.

FIGS. 5 and 5A illustrate an alternative embodiment of a drive member to the embodiment shown in FIG. 4.

FIGS. 6 and 7 illustrate another alternative embodiment of a drive member to the embodiment shown in FIG. 4.

FIGS. 8 and 9 illustrate yet another alternative embodiment of a drive member to the embodiment shown in FIG. 4.

FIGS. 10, 10A and 10B respectively illustrate elevational and sectioned views of a drive member embodiment comprising a potential energy storer such as first and second coil springs.

FIGS. 11, 11A and 11B illustrate an embodiment of a plural sectional eccentric bearing assembly.

FIG. 11C illustrates one form of frictional engagement surfaces operable to limit relative pivoting of the eccentric portion of the connecting rod bearing of FIG. 11 in the absence of a compression ratio adjustment force.

FIGS. 12 and 13 are schematic illustrations of forces on a connecting rod at respective top dead center and bottom dead center positions of a piston in a piston cylinder.

FIG. 14 illustrates an exploded sectional view of one form of connecting rod and eccentric connecting rod bearing.

FIG. 15 illustrates an exploded sectional view of another form of connecting rod and eccentric connecting rod bearing.

FIG. 16 is a front elevational view of a still further embodiment of an eccentric connecting rod bearing, the eccentric connecting rod bearing comprising an embodiment with a counter balance to the eccentric portion of the eccentric connecting rod bearing.

FIG. 17 is a sectional view of an embodiment of eccentric connecting rod bearing utilizing seals.

FIG. 18 schematically illustrates expected connecting rod forces for an exemplary engine operating at a speed of 4,000 revs/minute and at 40% load. The connecting rod forces pass through zero four times during the four strokes (intake, compression, working, exhaust) of the engine cycle in this example.

FIGS. 19-21 schematically illustrate tension and compression forces on the connecting rod at selected piston positions during a working cycle of a piston.

FIGS. 22, 22A and 22B illustrate respective front elevation, top and vertical sectional views of one form of a link or lever that can be used for coupling a drive member to an eccentric connecting rod bearing.

FIGS. 23 and 24 illustrate components of one form of a potential energy storer, in this example a coil spring and stop. The spring in this example being operable to store potential energy for use in adjusting the position of an eccentric connecting rod bearing when tension forces and compression forces in the associated connecting rod approach or reach reduced levels (e.g., zero) as the associated piston travels between top dead center and bottom dead center positions and between bottom dead center and top dead center positions.

FIG. 25 is a side elevational view, partially in section, of a crank shaft comprising an embodiment of a mass balancer that can be used to counter balance changes in the center of gravity due to pivoting movement of an eccentric portion of an eccentric connecting rod bearing.

FIG. 26 is a view of the mass balancer of FIG. 25, taken along line 26-26 of FIG. 25.

FIGS. 27, 27A and 27B are respective side elevation, top, and front views of one form of mass balance weight usable in the mass balancer of FIG. 25.

FIG. 28 is a vertical sectional view of a four cylinder variable compression ratio engine, only the piston for one cylinder being shown in FIG. 28, but with eccentric connecting rod bearing adjusters being shown for all of the cylinders, and also comprising a balance shaft positioned coaxially with and at least partially surrounding a compression ratio adjustment shaft, the compression ratio adjustment shaft being coupled by respective drive members to the eccentric connecting rod bearings.

FIG. 29 is an end view of the variable compression ratio internal combustion engine embodiment of FIG. 28, taken in the direction indicated by line 29-29 of FIG. 28.

FIG. 30 is a vertical sectional view through a portion of the variable compression ratio internal combustion engine of FIG. 28, taken along line 30-30 of FIG. 28.

FIG. 31 is a vertical sectional view of an embodiment of a variable compression ratio internal combustion engine comprising a form of compression ratio adjustment shaft that least in part surrounds a coaxial balance shaft.

FIG. 32 is an end view of the variable compression ratio internal combustion engine of FIG. 31, taken in the direction indicated by line 32-32 of FIG. 31.

FIG. 33 is a vertical sectional view through a portion of the variable compression ratio internal combustion engine of FIG. 31, taken along line 33-33 of FIG. 31.

FIG. 34 is a vertical sectional view through a portion of the balance shaft and compression ratio adjustment shaft of FIG. 31, taken generally along line 34-34 of FIG. 31.

FIG. 34A is an exploded view of selected shaft components depicted in FIG. 34.

FIG. 35 is a vertical sectional view of an embodiment of a variable compression ratio internal combustion engine comprising a compression adjustment shaft that supports a compression adjustment force generator with the compression adjustment force generator also coupling the compression adjustment shaft to a balance shaft that at least partially surrounds the compression adjustment shaft.

FIG. 36 is an end view of the variable compression ratio internal combustion engine of FIG. 35, taken in the direction indicated by the line 36-36 of FIG. 35.

FIG. 37 is a vertical sectional view through a portion of the variable compression ratio internal combustion engine of FIG. 35, taken along line 37-37 of FIG. 35.

FIGS. 38 and 39 are respective vertical sectional views of a variable compression ratio internal combustion engine utilizing drive members that are drivenly coupled together by drive belts.

FIG. 40 is a schematic illustration of an exemplary control system for a variable compression ration internal combustion engine comprising eccentric connecting rod bearings.

### DETAILED DESCRIPTION

The invention encompasses all novel and non-obvious assemblies, subassemblies and individual elements, as well as method acts, that are novel and non-obvious and that are disclosed herein. The embodiments described below to illustrate the developments are examples only as the invention is defined by the claims set forth below. Also, in this disclosure, the term “coupled” and “coupling” encompasses both a direct connection of elements and an indirect coupling of elements through or by one or more other elements. Also, the terms “a” and “an” encompass both the singular and the plural. For example, if “an” element or “a” element is referred to, this includes one or more of such elements. Thus, for example, if a plurality of specific elements of one type are present, there is also “an” element of the type described. The invention is also not limited to a construction which contains all of the features described herein.

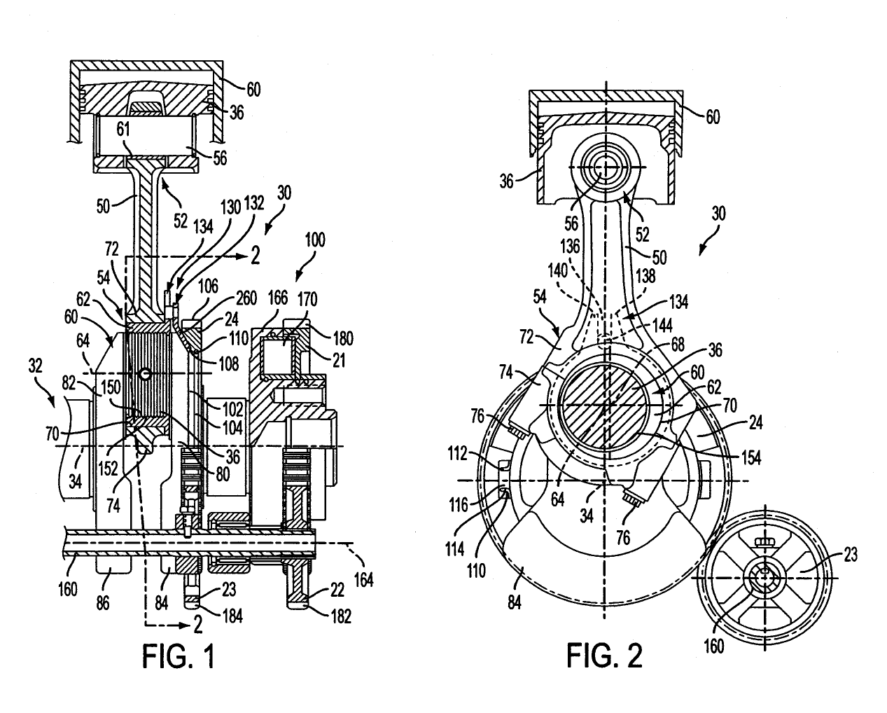

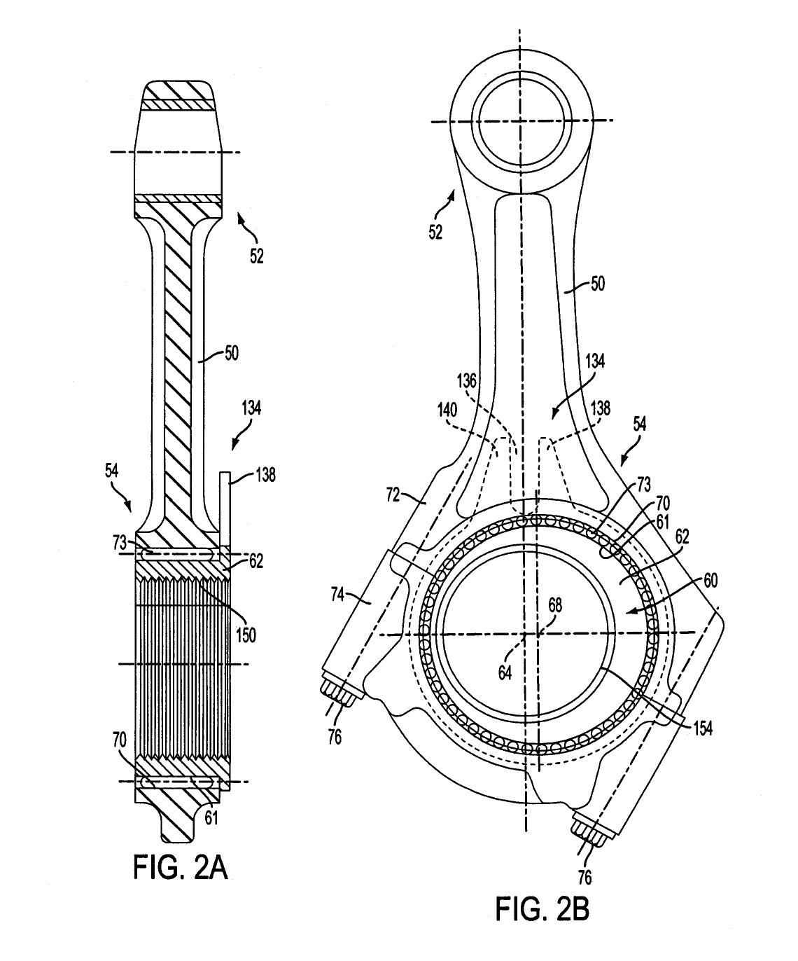

FIGS. 1 and 2 are sectional views through a portion of an embodiment of a variable compression ratio internal combustion engine, with only one cylinder of the engine being shown in FIG. 1. The engine 30 comprises a portion of an engine block (not shown) that pivotally supports a crank shaft 32 for rotation about a crank shaft axis 34. Typically, various bearings or bushings couple the crank shaft to an engine housing. The technological developments disclosed herein are not limited to engines with a specific number of cylinders as engines with at least one to any number of cylinders can utilize the technology. Engines disclosed herein can be used in a wide variety of applications, such as in land vehicles.

In FIGS. 1 and 2, a piston 36 is shown in a top dead center position. Since each of the pistons and associated engine components can be identical, like numbers are assigned to like or similar components for the various pistons and engine components throughout this disclosure. Thus, with reference to FIGS. 1 and 2, the crank shaft 32 comprises a connecting rod coupling portion such as a connecting rod pin portion 36 with one such crank shaft pin portion 36 being provided for each of the connecting rods included in the engine. A connecting rod 50 is shown with an upper piston coupling end portion 52 for pivotal coupling by a piston pin 56 to the piston 36. The piston 36 is slidably received by and reciprocates within a piston cylinder 60 between top dead center and bottom dead center positions as the crank shaft 32 is rotated. Bearings or bushings, such as indicated at 61 in FIG. 1, can be used to couple the piston pin 56 to the connecting rod end portion 52. Typically, piston rings, (not shown in FIGS. 1 and 2), are positioned within piston ring receiving grooves and slide in contact with the interior surface of the piston cylinder 60 to protect the cylinder against scoring by the piston and to provide a suitable seal at this location.

In the illustrated embodiment of FIGS. 1 and 2, a crank coupling end portion 54 of the connecting rod is pivotally coupled to the connecting rod coupling portion 36 of the crank shaft utilizing a crank shaft coupler with an eccentric such as explained below. Rotation of the crank shaft causes the connecting rod to reciprocate and move the piston between top dead center and bottom dead center positions. In the embodiment of FIGS. 1 and 2, an exemplary crank shaft coupler comprises an eccentric connecting rod bearing indicated at 60 with an eccentric portion indicated at 62. In addition, the connecting rod coupling portion or crank shaft pin 36 defines a first axis 64 that is parallel to the crank shaft axis 34 and positioned at the longitudinal center of the connecting rod pin portion 36 of the crank shaft.

The eccentric portion 62 of the eccentric connecting rod bearing 60 defines a second longitudinal axis 68 (FIG. 2) parallel to and offset from the first axis 64. With this construction, pivoting of the crank shaft connecting rod bearing 60, and thereby the eccentric portion 62, about the axis 64 from a first position to a second position pivots the eccentric portion 62 from a first eccentric position to a second eccentric position. This movement of the eccentric portion 62 shifts the second axis 68 relative to the crank shaft axis 34 to thereby vary the compression ratio of the associated piston cylinder. The same adjustment is made to the eccentric portion of each crank shaft connecting bearing of an engine so that the compression ratio of each of the piston cylinders is varied together. It is to be understood that, in a desirable construction, the position of eccentric portion 62 can be continuously varied within mechanical limits to continuously vary the compression ratio.

In the embodiment illustrated in FIGS. 1 and 2, the crank coupling end portion 54 of the connecting rod 50 defines an eccentric connecting rod bearing receiving bore 70 that pivotally receives the eccentric connecting rod bearing 60. In this example, an interior substantially right cylindrical surface of bore 70 pivotally engages the exterior substantially right cylindrical surface of the eccentric connecting rod bearing. The axis 68 in FIG. 2 corresponds to the longitudinal axis of the connecting rod bore 70. In addition, to facilitate the assembly of the structure, the crank coupling end portion 54 of the illustrated connecting rod 50 comprises an upper portion 72 that defines an upper portion of the bore 70 and a lower portion 74 that defines a lower portion of the bore 70. Fasteners, such as bolts 76, join the crank coupling end portion sections 72, 76 together when assembled on the connecting rod coupling portion 36 of the crank shaft. In a conventional manner, the illustrated crank shaft 34 comprises respective cheek portions 80, 82 with the connecting rod crank shaft pin portion 36 extending therebetween. Cheek portion 80 comprises a counterweight portion 84 and cheek portion 82 comprises a counterweight portion 86. The counterweight portions 84, 86 are positioned and of a mass that balances the mass of the portion of the crank shaft coupled to the connecting rod so that the center of gravity of the crank shaft is along axis 34.

A compression ratio adjuster, with one example indicated generally by the number 100 in FIG. 1, is used to adjust the position of eccentric portion 60 to thereby vary the compression ratio of the engine as desired. The compression ratio adjuster is coupled to the crank shaft coupler or eccentric connecting rod bearing 60 and is pivotable from a first compression ratio adjuster position to a second compression ratio adjuster position in response to a compression ratio adjustment force. In desirable embodiments, the compression ratio adjuster can shift the eccentric portion 62 of eccentric connecting rod bearing 60 to many positions and the position of the eccentric portion 62 can be continuously varied over its range of motion. Desirably, the compression ratio adjuster comprises an energy storage member (the term energy storage member encompassing and meaning one or more of such members) coupled to the compression ratio adjuster and to the crank shaft coupler. For example, the compression ratio adjuster can comprise a first portion, such as a drive member coupled to the crank shaft and also to the eccentric connecting rod bearing. In the embodiment shown in FIG. 1, one such drive member comprises a gear 24 coupled to the cheek 80 and thereby to the crank shaft. In the specific construction shown, the cheek 80 comprises a drive gear supporting or coupling portion 102 that can include a right cylindrical support surface having an annular spring ring receiving groove 104 provided therein. The illustrated gear 24 is annular with exterior gear teeth 106 and an interior crank coupling surface 108. The surface 108 can be configured to match the coupling surface 102 and thus, in this example, can be of a right cylindrical shape. In the example shown in FIG. 1, an annular recess is provided in surface 108 for receiving an annular retention spring ring 110 that detachably mounts the drive gear 24 to the crank shaft cheek. Respective spring end portions 112, 114 (see FIG. 2) of the spring 110 project radially outwardly and are positioned within an access opening 116. Drawing the spring end portions 112, 114 toward one another reduces the cross sectional dimension of spring 110 and removes the spring from the recess in surface 108, thereby freeing the drive gear 24 for removal from the crank shaft cheek 80. It should be noted that the drive member 24 can be mounted to or coupled to the crank shaft in any suitable manner. It should also be noted that the drive member 24 need not be a gear as this drive member, as well as other drive members described herein, can be respective belt or chain driven drive elements, for example. Also, combinations of belt and chain drive members can be used as drive members in the same engine.

In the FIGS. 1 and 2 embodiment, the compression ratio adjuster comprises a drive member to eccentric coupler 130 operably positioned to couple the drive member 24 to the crank shaft coupler or eccentric connecting rod bearing such that movement of the drive member 24 relative to the crank shaft shifts the position of the eccentric portion 62 of the crank shaft coupler. Although not limited to the illustrated construction, in one specific example, a link or lever 132 engages the drive member 24 and also a link engaging portion 134 of the eccentric connecting rod bearing. As can be best seen in FIG. 2, the link engagement portion 134 can comprise a projecting portion that defines a slot 136 that is bounded by first and second projecting legs 138, 140. A pin 144 projecting from link 132 in this example is slidably positioned within the slot 136 such that the drive member 24 engages the eccentric connecting rod bearing 60 via the link 132, pin 144 and link engaging portion 134.

In addition, the illustrated exemplary compression ratio adjuster comprises a compression ratio adjustment shaft 160 that is pivotal about a compression adjustment shaft axis 164 that is spaced from and parallel to the crank shaft axis 34. In addition, second and third spaced apart drive members 22, 23, which like drive member 24 can comprise gears, chain sets or belt drive members, for example, are mounted to the compression adjustment shaft 160. A first drive member, such as a drive gear 21, which can also, for example, alternatively comprise a drive chain or a drive belt driven member, is coupled to the crank shaft 32. More specifically, in this example the drive member 21 is coupled to a crank shaft flange 166 that is an integral part of the crank shaft. A flywheel, not shown, can be mounted to the crank shaft flange 166. Thus, in this example, the drive member 21 is indirectly coupled to a fly wheel of the crank shaft at one end portion of the engine. Alternatively, the drive member 21 can be positioned at the opposite end of the engine. Drive member 21 is drivenly coupled to drive member 22 such that motion of the drive member 21 relative to the crank shaft flange 166, and thus relative to the crank shaft 32, rotates drive members 22, 23, as well as the shaft 160, in the opposite direction to the direction of rotation of the drive member 21 because of the inter-engagement of these drive members. Drive member 23, as a result, rotates drive member 24 in the same direction as drive member 21 to thereby shift the eccentric portion 62 of the eccentric connecting rod bearing 60.

Drive member 21 can be driven in response to a compression ratio adjuster adjustment force. The compression ratio adjustment force can be provided by a compression ratio adjustment force generator that, in the FIG. 1 embodiment is coupled to the first drive member, namely drive gear 21 in this example. In the example shown in FIG. 1, the compression ratio force generator comprises a portion of the crank shaft flange 166 and drivenly interconnects the crank shaft flange 166 and drive member 21 and is represented by the number 170 in FIG. 1. Any suitable force generator can be used to accomplish the driving of drive member 21 relative to the crank shaft with hydro motors and electromagnetic motors being specific examples.

In the FIG. 1 construction, with the drive members 21, 22, 23 and 24 being drive gears, teeth 180 of drive member 21 engage the teeth 182 of drive member 22 and teeth 184 of drive member 23 engage the teeth 106 of drive member 24 to accomplish the driving of these respective drive members. As previously explained, when drive member 21 is pivoted, the first and fourth drive members 21, 24 in this embodiment turn in the same direction and the second and third drive members 22, 23 also turn in the same direction and in a direction that is opposite to the direction of turning of the first and fourth drive members 21, 24. The drive member 21 can be mounted to rotate freely on the fly wheel 166 and can be fixed to the force generator 170, such as a hydro motor. In this exemplary embodiment, the gear ratios and turning orientation of gear set 21 to 22 and gear set 24 to 28 is identical. For example, the drive ratio of gear 21 to gear 22 can be 2 to 1 and the drive ratio of gear 23 to gear 24 can be 1 to 2. In addition, looking from the right in FIG. 1, the turning orientation or direction of rotation of gear 21 can be clockwise, of gear 22 can be counterclockwise, of gear 23 can be counterclockwise and of gear 24 can be clockwise. With this construction, the gear 24 rotates in the same direction and with the same speed as the gear 21. As a result, when the crank shaft 32 rotates, gear 24 rotates in an identical manner as the crank shaft cheek 80 and thereby the crank shaft (thus there is no relative pivotal movement between these components) in the absence of the compression ratio adjustment force. Thus, the gear 24 rotates, in the absence of a variable compression ratio adjustment force in the same manner as the crank shaft. In the case of a two or a four cylinder engine, the drive ratio of drive member such as gear 21 to drive member such as gear 22 is 2 to 1 and the drive ratio of drive member such as gear 23 to drive member such as gear 24 is 1 to 2. In the case of a one or a three cylinder engine, the drive ratio of drive member such as gear 21 to drive member such as gear 22 would be 1 to 1 and the drive ratio of drive member such as gear 23 to drive member such as gear 24 would be 1 to 1. Engines with five or more cylinders can have a drive ratio of drive member 21 to drive member 22 that is 1 to 1 (with the drive ratio of drive member 23 to drive member 24 being 1 to 1) or 2 to 1 (with the drive ratio of drive member 23 to drive member 24 being 1 to 2). For space saving reasons, in these five or more cylinder engines, 1 to 2 and 2 to 1 drive ratios of drive members of drive member 21 to 22 and drive member 23 to drive member 24 are more desirable.

As will be explained more fully below, at certain positions during a piston's cycle (such as at top dead center and bottom dead center positions and at other positions during a piston cycle), the compression or tension forces on a connecting rod are relatively high. As a result, the torque required to turn the eccentric portion of an eccentric bearing connecting rod bearing that couples a connecting rod to a crank shaft would be extremely high under these high compression or tension force conditions. In contrast, at other times during a piston cycle, the compression and tension forces are reduced with forces on the connecting rod typically transitioning at least once and more typically a plurality of times through zero during the course of a piston cycle. By including at least one energy storage member operatively coupled to a first portion of the compression ratio adjuster and to the crank shaft coupler, in response to a compression ratio adjustment force, energy can be stored as potential energy by the energy storage member. This potential energy can be applied to the eccentric connecting rod bearing so as to shift the position of the eccentric portion of the eccentric connecting rod bearing when the compression and tension forces in the connecting rod are insufficient to resist pivoting of the eccentric portion of the crank shaft coupler by the potential energy. Shifting of the crank shaft coupler eccentric portion is accomplished as the associated piston approaches or reaches positions where the compression and tension forces in the connecting rod are reduced, such as where they approach or reach zero. If complete pivoting of the eccentric portion is not accomplished during one of these low compression/tension force positions of the connecting rod, as the connecting rod passes through or reaches another of these compression/tension force or zero force transition regions, further pivoting of the eccentric can be accomplished, thereby completing the pivoting of the eccentric portion to the new desired position.

The energy storage member can be positioned at any suitable location to accomplish this function. For example, the energy storage member can be incorporated into the drive member 24 such that driving of the drive member 24 in response to the compression ratio adjustment force stores potential energy that is applied to the link 132 with the link then being moved to pivot the eccentric portion as compression and tension forces in the connecting rod are reduced. For example, one or more springs, such as coil springs, can be used to couple the link 132 to the drive member 24. These springs can be compressed or tensioned to store potential energy upon rotation of the drive member 24 relative to the link 132. The stored energy in the springs can then move the link relative to the drive member to turn the eccentric portion of the eccentric connecting rod bearing when the stored potential energy is greater than forces resisting such turning. As another alternative, one of the other drive members, such as drive member 23, can comprise the energy storage member.

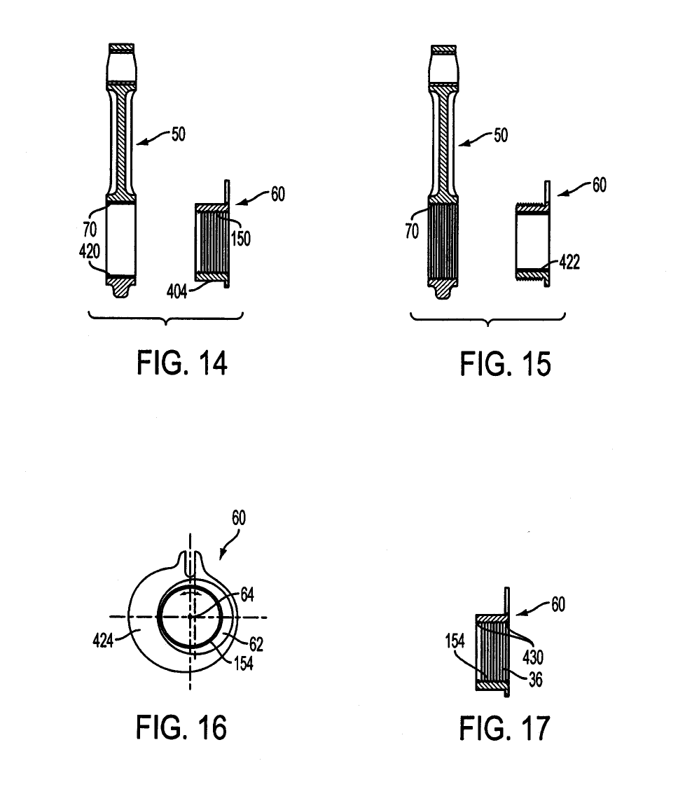

In addition, it is undesirable for the eccentric portion to turn spontaneously or in an uncontrolled manner in the absence of a compression ratio adjustment force. Such spontaneous turning could arise due to eccentricity torque forces applied by the connecting rod to the eccentric bearing as the connecting rod reciprocates, and eccentric bearing friction torque forces that arise during operation of the engine. To prevent such spontaneous turning, first and second engagement surfaces can be provided that are operable to frictionally resist any such spontaneous turning. For example, the engagement surfaces can be positioned on or between the connecting rod bore 70 and the eccentric connecting rod bearing 60, on or between the eccentric connecting rod bearing 60 and the crank shaft connecting rod pin 36. These first and second engagement surfaces are configured to allow pivoting of such surfaces relative to one another so as to allow pivoting of the eccentric portion of the eccentric bearing in response to the compression ratio adjustment force, yet provide frictional resistance to prevent spontaneous pivoting of the eccentric portion of the eccentric connecting rod bearing 62 in the absence of the compression ratio adjustment force. These first and second engagement surfaces can comprise engaging features. In the example of FIG. 1, these engaging features can comprise surfaces of grooves, threads, annular rings or ridges, or other surface features, such as plural spaced apart parallel grooves indicated at 150 in FIG. 1 at the interior surface of the eccentric bearing 60. Mating or interfitting threads, grooves, annular rings, ridges or other surface features 152 can be provided on the exterior surface of the crank shaft connecting rod pin or connecting rod coupling portion 36 with the features 152 being configured to frictionally engage the features 150. The interface between these features is indicated at 154 in FIG. 2. As an alternative, one or both of these engagement surfaces can simply be roughened to provide added friction therebetween, while permitting relative pivoting of these components, providing that sufficient friction results from these first and second engagement surfaces to prevent the spontaneous pivoting of the eccentric portion 62 of eccentric connecting rod bearing 60 in the absence of a compression ratio adjustment force. Alternative exemplary configurations and positions of these engagement surfaces are described below, such as in connection with FIGS. 14-17 below.

FIGS. 2A and 2B illustrate an alternative form of connecting rod 50 and eccentric connecting rod bearing 60 having a needle bearing 73 positioned between the exterior surface 61 of the eccentric connecting rod bearing 60 and the connecting rod bore 70.

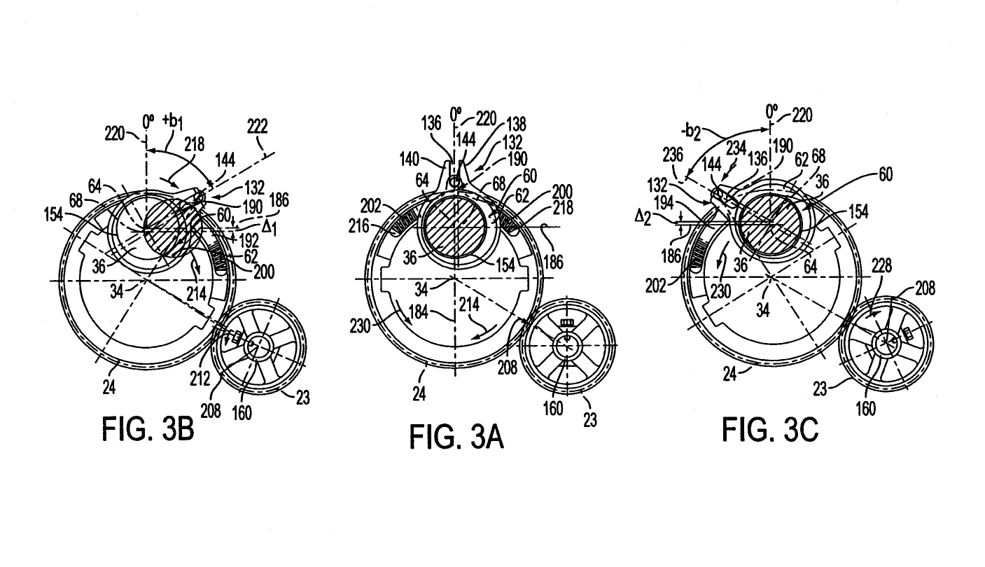

With reference to FIGS. 3A, 3B and 3C, the adjustment of the compression ratio of the engine of FIG. 1 will be explained more fully with reference to one example. In each of these figures, the position of the eccentric portion 62 of the eccentric bearing 60 is shown when the connecting rod and associated piston is in a top dead center position. In FIG. 3A, the compression ratio is in a mid-position. In this position, the axes 64 and 68 are along the same horizontal line. In addition, in this mid-position, the crank shaft axis 34; the axis 64 and the slot 136 are all aligned along a vertical line 184. The line 186 through axes 64 and 68 corresponds to a reference or mid-position compression ratio of the engine. As can be seen in FIGS. 3A, 3B and 3C, the illustrated link member 132 comprises a body with a central or intermediate portion having a radially outwardly projecting pin supporting portion 190 (FIG. 3B), an arcuate first leg portion 192 extending in a clockwise direction from the central portion (FIG. 3B) and an arcuate second leg portion 194 extending counterclockwise from the central portion (FIG. 3C). In this example, the energy storing or biasing members comprise respective coil springs 200, 202. The spring 200 is coupled to the end of leg portion 192 and the spring 202 is coupled to the end of leg portion 194. In FIG. 3A, the drive member 23 is shown engaged to the drive member 24 at an engagement location or region 208.

To reduce the compression ratio, in response to a compression ratio adjustment force, the drive member 23 is driven in the direction indicated by arrow 212 (FIG. 3B) and causes the drive member 24 to move in the direction of arrow 214 (FIGS. 3A, 3B). In this example, location 208 is correspondingly shifted as shown in FIG. 3B. Assuming that pivoting of drive member 24 occurs at a time when tension or compression forces on the connecting rod are relatively high, drive member 24 will rotate in the direction of arrow 214, but the eccentric portion 62 remains in the position shown in FIG. 3A. A stop engaging member 216 coupled to a distal end portion of spring 202 engages a stop surface of drive member 24 and is compressed under these conditions to store potential energy. When the tension and compression forces on the connecting rod reach or approach a reduced or zero force condition, the spring 202 then expands and causes the movement of the eccentric portion 62 in the direction of arrow 218 (shown in FIG. 3B) to thereby shift the eccentric portion 62 from a zero degree position indicated by line 220 in FIG. 3B (also shown in FIGS. 3A and 3C) through an angle ⁺β₁ to a position indicated by line 222 in FIG. 3B. When the eccentric connecting rod bearing 60 is in the position shown in FIG. 3B, the potential energy stored in spring 202 has been exhausted. The compression adjustment force can be adjusted to shift eccentric portion 62 to any location between positions 220 and 222, assuming location 222 is the maximum allowed shifting of the eccentric in the direction of arrow 218. Although this can be changed, in the example of FIG. 3B, ⁺α₁ can be 60 degrees.

In contrast, assume it is desired to increase the compression ratio of the engine from the compression ratio that exists when the eccentric portion 62 is in the position shown in FIG. 3A. In this case, the drive member 23 is pivoted in response to a compression ratio adjustment force in a direction of arrow 228 (FIG. 3C) to thereby shift the location 208 to the position shown in FIG. 3C. Assume that the connecting rod is in a position where tension and compression forces are not reduced when drive member 23 is pivoted. In this case, drive member 24 pivots in the direction indicated by arrow 230 (FIGS. 3A, 3C) but the position of eccentric portion 62 remains unchanged. A stop engaging member 218 coupled to the distal end of spring 200 engages a stop surface of drive member 24, causing the compression of spring 200 and the storing of potential energy by this spring. Thereafter, when the compression and tension forces in the connecting rod are reduced, such as transition through zero, the potential energy stored in spring 200 moves the eccentric portion 62 in the direction indicated by arrow 234 in FIG. 3C and results in an increase in the compression ratio of the engine. In FIG. 3C, the drive member 24 is shown in a position following exhaustion of the potential energy from the spring 200. In this case, the eccentric portion 60 has been shifted through an angle indicated as ⁻β₂ from the position indicated by line 220 to the position indicated by line 236. Although not necessary, typically the absolute value of ⁺β₁ and ⁻β₂ are the same and thus ⁻β₂ can be, for example, minus 60 degrees assuming line 220 is a reference of zero degrees.

In shifting the eccentric from the position shown in FIG. 3A to the position shown in FIG. 3B, the axis 68 has been shifted relative to the axis 64 by a distance Δ₁ (delta₁) such that the associated piston will travel upwardly within the associated piston cylinder to a top dead center position in FIG. 3B that is Δ₁ below the top dead center position of FIG. 3A. In contrast, when in the position shown in FIG. 3C, the axis 68 has been shifted relative to the axis 64, and thus relative to the crank axis 34, by a distance Δ₂ (delta₂). Consequently, the piston will be inserted at a top dead center position a distance Δ₂ further into the cylinder than in the position shown in FIG. 3C, thereby increasing the compression ratio.

Thus, in this example, when the adjustment of the variable compression ratio engine occurs, drive member 24 builds up a spring force that is transmitted via lever or link 132 to the eccentric connecting rod bearing. As soon as the connecting rod forces reach areas where they are low, such as at transitions through zero, the spring force turns the eccentric connecting rod bearing to the position established by the movement of the drive member 24, and thus by an engine controller that can be used to control the operation of the compression ratio adjustment force generator.

As a more specific example, assume that the engine is a gasoline engine with a piston bore of 84 mm in diameter and a stroke of 90 mm. In this example, the total difference (Δ₂−Δ₁) of the piston position in the top dead center position from epsilon fourteen to epsilon eight is 5.95 mm. Assuming an eccentric bearing is to be turned a maximum of 120 degrees between the epsilon maximum and epsilon minimum positions, an eccentricity of 3.43 mm would result in this total piston position difference in the top dead center positions. In the above example, the compression ratio adjustment force can be provided by a force generator, such as a motor, with a hydro motor or electromagnetic motor being examples thereof. In the case of a hydro motor, the motor is pressurized to drive the drive member 21 (FIG. 1) relative to the crank shaft. As a result, drive members 22 and 23 turn drive member 24 as previously described to adjust the eccentricity of the eccentric portion 62 of the eccentric bearing 60 to thereby vary the compression ratio.

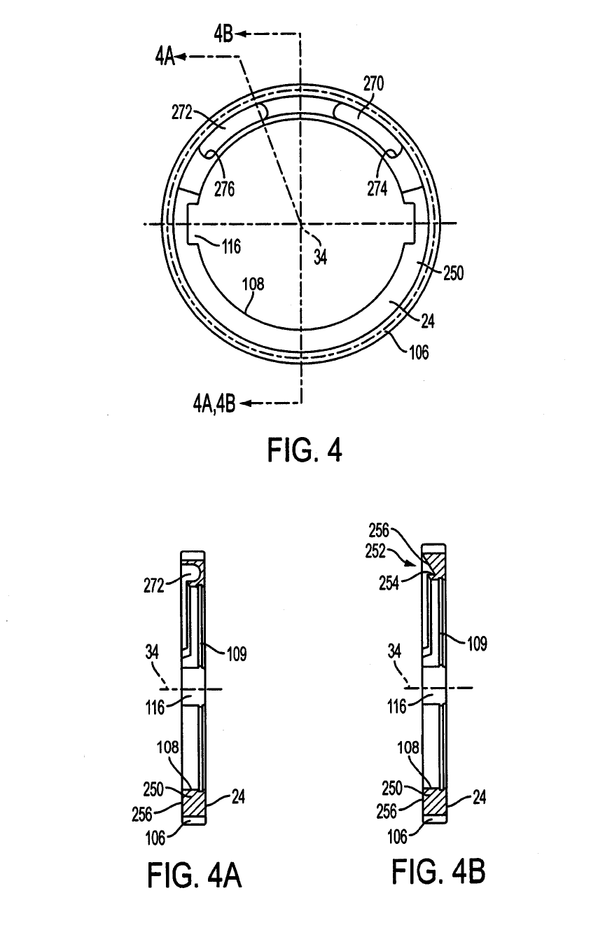

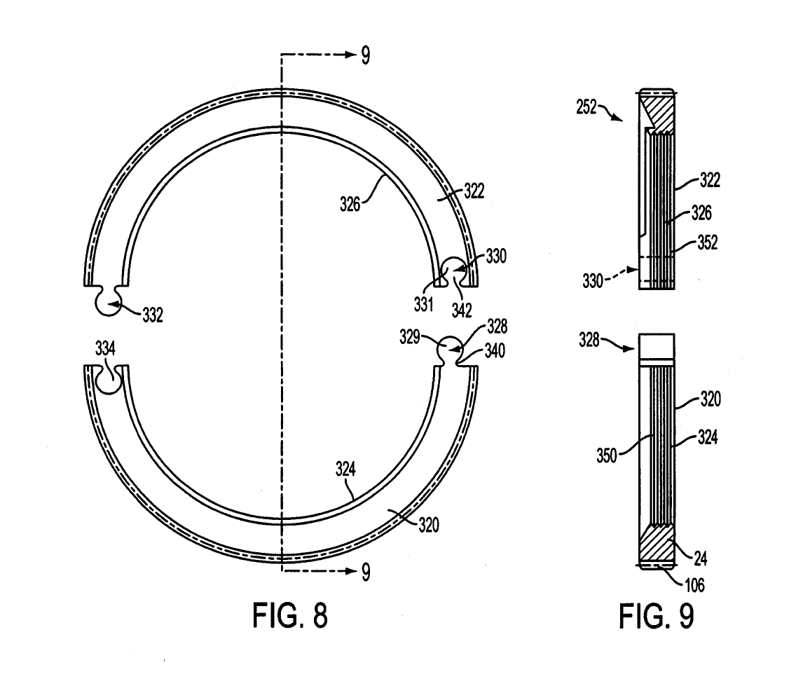

With reference to FIGS. 4, 4A and 4B, one form of a drive member 24 in the form of a drive gear is shown. The drive member 24 comprises a body 250 and in the illustrated form is annular with a crank cheek member engaging interior surface 108 that conforms to a supporting surface 102 of the crank cheek 80 (FIG. 1). This surface 108 can be of a generally right cylindrical shape to conform to an exemplary right cylindrically shaped supporting surface 102 of the crank cheek 80 that is shown in FIG. 1. The term annular in this example does not preclude the presence of breaks in the surface, such as the gap 116 shown in FIG. 4 to provide access to a spring ring 110 used in this example (see also FIG. 2) to axially fix the drive member 24 to the crank cheek. In this example, an annular spring ring receiving groove 109 is recessed into the interior of surface 102 and a similar groove is provided in surface 108 for receiving the spring 110 shown in FIG. 1. Positioning of the spring ring in these two grooves secures the drive member to the crank shaft so as to permit pivoting of the drive member relative to the crank shaft and to prevent axial motion of the drive member. A crank cheek facing recess 252 is provided in an interior surface of the body 250 that faces the crank cheek. The recess 252 is configured to receive the link or lever 132 (shown in FIG. 1) and cooperates with an exterior surface 260 of the crank cheek 80 (see FIG. 1) to receive and guide the motion of the lever or link 132. The recess 252 can be arcuate in shape with an inclined or sloped link guiding wall surface 256 (FIG. 4B) positioned to engage a side wall of the link 132 (FIG. 1) opposite to and spaced from a link guiding surface 260 of the crank cheek 80 (FIG. 1). In addition, the recess 252 can comprise an arcuate base portion 254 that receives and supports a base of the link 132. The illustrated drive member 24 shown in FIGS. 4 and 4A also includes first and second spring receiving recesses or channels 270, 272 for receiving the respective springs 200, 202 (the springs being shown in FIG. 3A). An end wall 274 of channel 270 can comprise a stop for engaging the stop member 218 coupled to spring 200, the operation of which has been explained above. In addition, an end wall 276 of spring receiving channel 272 can cooperate with a stop member 216 coupled to spring 202, as explained above. The drive member shown in FIG. 4 can comprise a plurality of arcuate sections with locking features that can selectively be locked together to retain the sections together, such as described below in connection with FIG. 8. Similarly, the other drive member embodiments can comprise plural arcuate drive member sections with such interfitting and interlocking features.

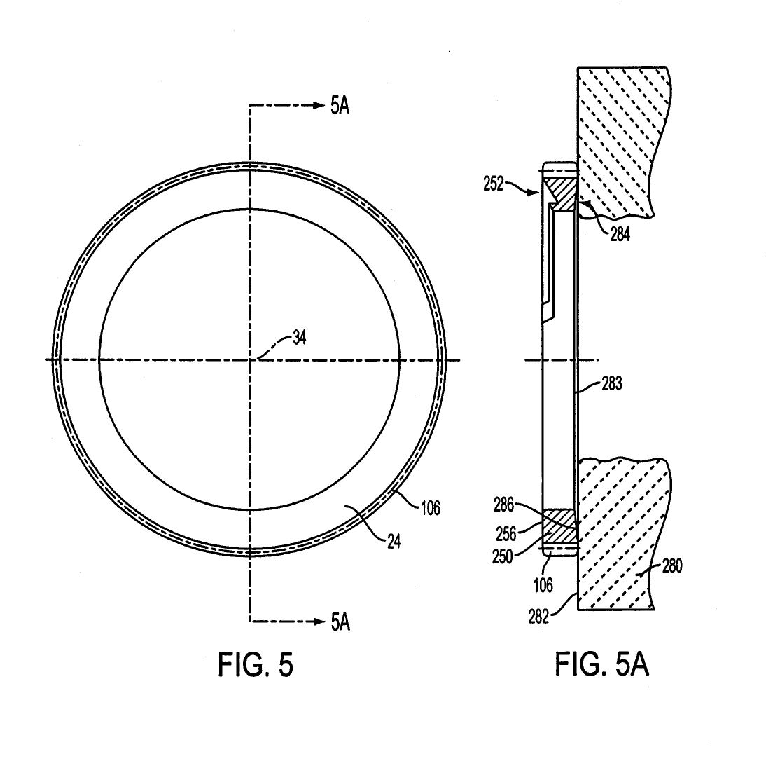

FIGS. 5 and 5A illustrate an alternative form of drive member 24. In this embodiment, there is no specific axial fixation of the drive member onto a crank shaft or crank shaft cheek. For example, the spring 110 shown in FIG. 1 and the spring receiving groove shown in FIG. 4B can be eliminated. Instead, the crank case within which the crank shaft is positioned is provided with a drive member engaging wall 280 with a drive member engaging surface 282. The exterior major surface 284 of the drive member 24, facing generally away from the eccentric connecting rod bearing and opposite to the major surface that generally faces the connecting rod bearing, slides against the surface 282 to maintain the axial position of the drive member at a desired axial location along the length of the crank shaft. The exterior surface 283 of the drive member, opposite to drive member surface 256 can be, for example, of a convex shape to reduce the friction between surfaces 282 and 283. The surface 282 of the crank case wall can be planar or flat where it engages surface 283 of the drive member. In the embodiment of FIG. 5, spring receiving recesses are typically provided in the surface 256 (such as recesses 270, 272 shown in FIG. 4A). However, the gaps 116 that provide access to a retaining spring can be eliminated since a retaining spring (such as spring 110 in FIG. 1) can be eliminated in the embodiment of FIGS. 5 and 5A.

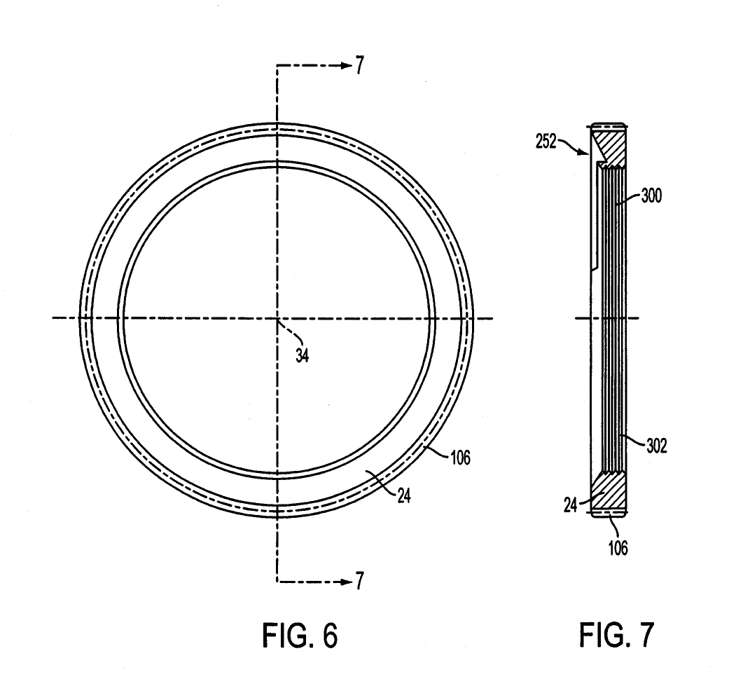

With reference to FIGS. 6 and 7, an alternative form of drive member 24 such as a drive gear is shown. In this embodiment, axial fixation, meaning limiting the axial shifting of the drive member in the direction of the crank shaft axis, is accomplished using a threaded connection between the drive member 24 and the crank cheek 80 of FIG. 1. More specifically, the surface 102 (FIG. 1) of the crank cheek can be provided with threads. In addition, an interior surface 300 of drive member 24 is provided with corresponding threads 302 so that the drive member 24 can be threaded onto the crank cheek surface 102. In this case, the retaining spring 110 (shown in FIG. 1) and the spring engaging access feature 116 of the drive member can be eliminated.

FIGS. 8 and 9 illustrate yet another example of a drive member 24, such as a drive gear. In the example of FIGS. 8 and 9, the drive member 24 comprises plural arcuate sections that, when assembled, comprise an annular drive member. In the example of FIGS. 8 and 9, two such drive sections 320, 322 are provided, each being semi-circular in shape and comprising respective interior surfaces 324, 326. The illustrated sections 320, 322 comprise interfitting locking features that, when interlocked, mate with one another to selectively secure the arcuate sections together to comprise the drive member. In the example shown in FIG. 8, the illustrated interfitting features comprise a projecting portion 328 of section 320, a projection receiving socket portion 330 of section 322, a projecting portion 332 of section 322 and a projection receiving socket portion 334 of section 320. The respective projections and sockets are configured such that when assembled, the projections are retained in the sockets. More specifically, the projections can comprise an enlarged head portion, such as a generally circular head portion 329 (for element 328) with a neck portion 340 of reduced cross-sectional dimension. The recess 330 (for receiving projection 329) can comprise a first portion 331 of an enlarged cross-sectional dimension configured to receive the head portion 329 of the projection 328 and a necked down or narrowed neck receiving portion 342 configured to accommodate the neck 340 of the projection 328. In addition, the respective interior surfaces 324, 326 of the sections 320, 322 can comprise engaging surfaces such as threads for engaging corresponding threads of the cheek 80 (FIG. 1) that are provided on the surface 102 of the cheek. The use of threads positions the drive member 24 relative to the crank shaft and prevents axial shifting of the drive member. The use of a plural section drive member facilitates assembly of the drive member onto the crank shaft.

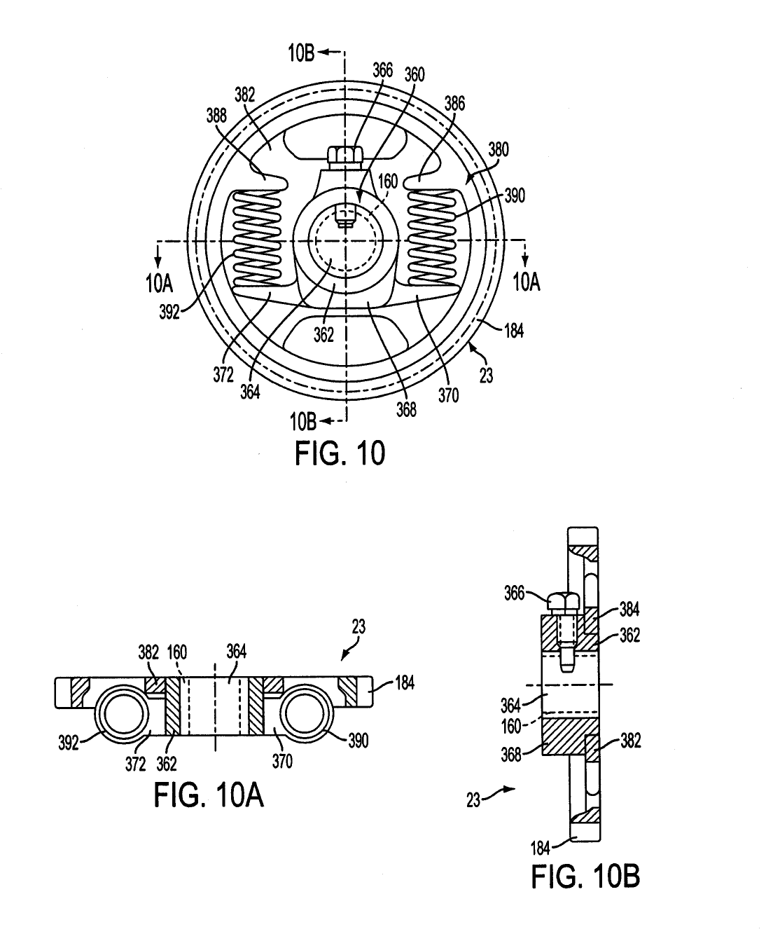

FIGS. 10, 10A and 10B illustrate an alternative form of drive member 23. Although not limited to a drive gear, in the example of FIG. 10, the drive member 23 is illustrated as comprising a drive gear with teeth 184. The embodiment of FIGS. 10, 10A and 10B illustrate another exemplary form of potential energy storing mechanism. The energy storing features of this embodiment can also alternatively be utilized in connection with the drive member 24 if desired. In the embodiment depicted in these figures, the drive member 23 comprises a first drive member portion 360 and a second drive member portion 380 that are pivotal relative to one another. In this specific example, the drive member portion 360 comprises a hub portion 362 having a central opening 364 therethrough sized to receive the compression adjustment shaft 160. The hub portion can be fixed to the shaft 160, such as using a bolt or other fastener 366 positioned to secure these respective elements together. The hub portion 362 comprises a base 368 with first and second spring supports 370, 372 projecting outwardly from the base toward the periphery of the drive member. The second drive member portion 380 in this example comprises the gear teeth 184, in the case of a drive member 23 that is a drive gear. In addition, drive member portion 380 comprises an interior body portion 382 defining a hub receiving opening 384 (FIG. 10B) sized to permit mounting of drive member portion 380 onto the hub 364 such that portions 360, 380 are pivotal relative to one another. In addition, drive member portion 380 includes first and second inwardly projecting spring engaging members 386, 388 positioned, in this example, spaced from, and opposite to, the respective projections 370, 372. In this embodiment, at least one biasing spring 390 engages projections 370 and 386 with the spring 390 being positioned therebetween. In addition, in this embodiment, at least one biasing spring 392 engages the respective projections 372 and 388, and is positioned therebetween.

The springs 390, 392 can be coil springs and operate to store potential energy upon rotation of the shaft 160 in response to the application of a compression adjustment force in the same manner as the springs 200, 202 described above in connection with FIGS. 3A, 3B and 3C. That is, if the drive member 23 pivots in response to the application of a compression adjustment force in one direction and the compression and tension forces in the connecting rod are such that the eccentric portion 62 of the eccentric connecting rod bearing 60 is prevented from pivoting, one of the two springs 390, 392 is compressed while the other of the two springs 390, 392 is tensioned, thereby storing potential energy. When the tension and compression forces on the connecting rod are sufficiently reduced, this potential energy is released and causes the drive member 24 to pivot the eccentric portion 62 of the eccentric connecting rod bearing 160 in the desired direction. Again, the potential energy storage mechanism illustrated in FIG. 10 can be incorporated into the drive member 24 in addition to or instead of the potential energy storing mechanism of the drive member 24 described above in connection with FIG. 3A. Also, the FIG. 10 energy storage mechanism can be used in addition to the FIG. 1 energy storage mechanism although typically only one potential energy storing mechanism is used.

It should be again noted that the examples of FIGS. 1 and 10 are simply illustrations of exemplary mechanisms that can be used to store potential energy for use in pivoting an eccentric portion 60 of an eccentric connecting rod bearing 62 when tension or compression forces on a connecting rod are reduced or are in a zero or minimized force condition.

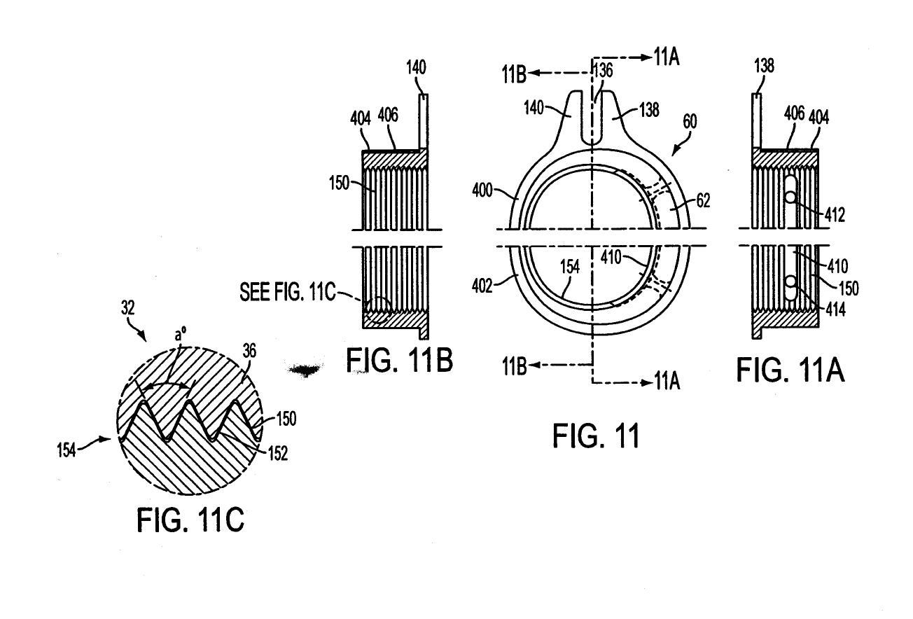

FIGS. 11, 11A, 11B and 11C illustrate one embodiment of an exemplary eccentric connecting rod bearing 60. The illustrated eccentric bearing 60 comprises plural, in this case two, eccentric connecting rod bearing sections 400, 402 that facilitate assembly of the eccentric bearing onto the connecting rod coupling portion or crank shaft pin 36 of the crank shaft 32 (a portion of the crank shaft being shown in FIG. 11C, but eliminated from the other figures). The exemplary eccentric rod bearing assembly shown in FIG. 11 comprises a series of grooves and ridges that are annular in configuration to permit relative pivoting of the eccentric connecting rod bearing and crank shaft. These interengaging features can alternatively be threads, rings or other features that provide frictional resistance to pivoting of the eccentric connecting rod bearing in the absence of an applied compression adjustment force. These surface features are shown on the interior surface of the eccentric connecting rod bearing in this example, with corresponding features being provided, in this example, on the exterior surface of the connecting rod coupling portion or crank pin portion 36 of the crank shaft. In addition, the exterior surface 404 of the eccentric connecting rod bearing can have bearing metal or other bearing material, for example copper bronze at the exterior surface thereof for engaging a corresponding surface of a connecting rod bore. Alternatively, the bearing material 406 can be replaced with a needle bearing. Alternatively, the surface 404 of the eccentric connecting rod bearing can be machined (for example ground) to have a bearing surface quality. In the embodiment of FIG. 11, an interior lubrication distribution or delivery cavity 410 is recessed into the interior surface of the eccentric connecting rod bearing. The illustrated cavity extends about a portion of the circumference of the connecting rod bearing. One or more apertures or openings, such as passageways 412, 414, communicate from the exterior surface of the eccentric connecting rod bearing to the cavity so as to allow lubricant, such as oil, to flow inwardly through openings 412, 414 to the surfaces between the crank shaft and eccentric connecting rod bearing. The cavity 410 is sufficiently long, that is spans enough of the eccentric connecting rod bearing, to prevent closure of the bore in the crank shaft pin that provides oil under pressure as the eccentric portion of the eccentric connecting rod bearing is moved between its maximum positions and relative to the crank shaft.

In the embodiment illustrated in FIG. 11C, the engaging surfaces of the crank shaft 36 and of the interior of the eccentric connecting rod bearing comprise interfitting substantially V-shaped grooves and interfitting substantially V-shaped ridges. The illustrated grooves and ridges have side walls with an angle alpha (α) therebetween. Alpha can be selected such that the frictional resistance between the engaging surfaces 150, 152 is greater than the sum of the eccentricity torque and the bearing friction torque, the bearing friction torque being the torque between the connecting rod and crank shaft coupler.

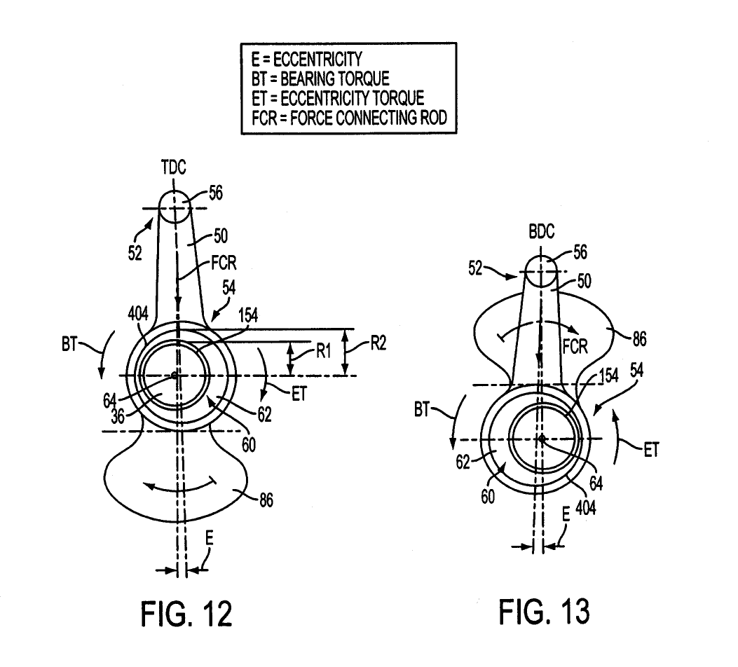

With reference to FIGS. 12 and 13, a schematic illustration of a portion of an engine is shown having a connecting rod 50, an eccentric connecting rod bearing 60, a counterbalance 86, a piston pin 56 and an eccentric portion 62 having a maximum eccentricity E. Also, the upper piston coupling portion 52 of the connecting rod 50 is shown together with the lower crank shaft coupler portion 54. In addition, the interface between frictional surfaces is indicated at 154 and the bearing surface 404 is also shown. When the piston is in the top dead center position, as shown in FIG. 12, forces on the connecting rod are indicated by FCR, bearing friction torque forces are indicated by BT and eccentricity torque forces ET (due to the application of the forces FCR along a line offset by the eccentricity from the axis of the crank shaft connecting rod) are shown. In FIG. 12, the bearing friction torque forces offset (are subtractive to) the eccentricity torque forces. In FIG. 13, at the bottom dead center position, the bearing torque forces and eccentricity torque forces are additive. The surfaces that engage one another, such as surfaces 154 (an example of which has been shown in FIG. 11C) are configured to provide sufficient friction to resist uncontrolled or spontaneous pivoting of the eccentric portion 62 of the eccentric connecting rod bearing 60 as a result of these applied eccentricity torque and bearing friction torque forces, as well as any other torque forces arising from the operation of the engine.

Desirably, these resistance forces are greater than the maximum total of the eccentricity torque and bearing torque forces by a safety factor (in other words, greater than one). In one desirable approach, the interengaging surfaces are angled relative to one another at an angle α. In one specific example, α can be 50 degrees. The angle α can be chosen for a particular engine to provide a safety margin that prevents undesirable spontaneous or uncontrolled turning of the eccentric portion 62 of the eccentric connecting rod bearing 60 as the piston travels between top dead center and bottom dead center positions, thus offsetting the forces generated by the operating engine (e.g., eccentricity torque and bearing friction torque). The grooves, ridges, rings or threads in this example, increase the transmittable torque and thereby can be used to accommodate turbo-charged, but downsized, engines. Consider the following force calculations for the example of FIGS. 12 and 13, with a in FIG. 11C selected to be 50 degrees.

Calculation Safety Factor (SF) against uncontrolled turning of the ECRB

Eccentricity E=3.43 mm (0.00343 m)

Radius R1=26 mm (0.026 m)

Radius R2=33 mm (0.033 m)

Friction Coefficient FC=0.1 (Steel/Steel; oiled)

Friction Coefficient FC=0.05 (Steel/Bearing Metal; pressure oiled)

Groove angle Alpha=50°; Alpha/2=25°

sin alpha/2=0.4226

Top Dead Center (TDC) (firing point)

$$Force Connecting Rod ( FCR ) = 70.000 N$$

$$\begin{matrix}Eccentricity Torque ET = FCR \times E \\ = 70.000 N \times 0.00343 m \\ = 240 Nm\end{matrix}$$

$$\begin{matrix}Bearing Torque BT = FCR \times R 2 \times FC \\ = 70.000 N \times 0.033 m \times 0.05 \\ = 115.5 Nm\end{matrix}$$

$$Friction Torque FT ( Holding Torque ) in R 1 ( grooved surface ) = \frac{FCR \times R 1 \times FC}{sin Alpha / 2} = \frac{70.000 N \times 0.026 m \times 0.1}{0.4226} = 430.7 Nm$$

$$\begin{matrix}Safety Factor SF \frac{FT}{ET - BT } = \frac{430.7 Nm}{240 Nm - 115.5 Nm} \\ = \frac{430.7 Nm}{124.5 Nm} \\ = 3.46\end{matrix}$$

Bottom Dead Center (BDC)

$$Force Connecting Rod ( FCR ) = 15.500 N$$

$$\begin{matrix}Eccentricity Torque ET = FCR \times E \\ = 15.500 N \times 0.00343 m \\ = 53.2 Nm\end{matrix}$$

$$\begin{matrix}Bearing Torque BT = FCR \times R 2 \times FC \\ = 15.500 N \times 0.033 m \times 0.05 \\ = 25.6 Nm\end{matrix}$$

$$Friction Torque FT ( Holding Torque ) in R 1 ( grooved surface ) = \frac{FCR \times R 1 \times FC}{sin Alpha / 2} = \frac{15.500 N \times 0.026 m \times 0.1}{0.4226} = 95.4 Nm$$

$$\begin{matrix}Safety Factor SF \frac{FT}{ET - BT } = \frac{95.4 Nm}{53.2 Nm - 25.6 Nm} \\ = \frac{95.4 Nm}{78.8 Nm} \\ = 1.21\end{matrix}$$

Thus, in the above example, the friction or holding torque arising from the engaged frictional surfaces is higher than the sum of the eccentricity torque and other sources of torque arising from engine operation (e.g., the bushings/bearings friction torque) at both the top dead center and bottom dead center positions (and thus at positions therebetween). Consequently, this means that the eccentric portion of the eccentric connecting rod bearing will not be allowed to pivot in the absence of controlled pivoting by operation of a compression ratio adjuster as previously described. In the above example, the safety factor is present in each case since the resulting ratio is greater than 1.0 (3.41 in the top dead center position and 1.21 in the bottom dead center position).

Desirably, to avoid a negative influence on the material properties of the crank shaft, the grooves or other surface friction features formed on the crank shaft, except for fine grinding or other surface finishing of the formed surface features, can be manufactured or formed without span removing methods (e.g., machining), but instead utilizing compression manufacturing methods such as precision forging or pressure rolling. Engagement surfaces formed on the eccentric connecting rod bearing can be formed in the same manner or alternatively by machining or other material removing processes as eccentric connecting rod engagement surfaces are subjected to lower stresses than engagement surfaces on the crank shaft coupling portions.

FIGS. 14 and 15 illustrate alternative forms of eccentric connecting rod bearings and in some cases connecting rods.

The connecting rod 50 and eccentric bearing 60 shown in FIG. 14 is similar to the embodiment of FIG. 11 except that the exterior surface 404 of the eccentric connecting rod bearing comprises a bearing surface achieved, for example, by machining or grinding this surface to have a bearing quality. In addition, bearing metal 420 can be applied to the interior surface of the connecting rod bore 70 of the connection rod 50.

In the embodiment of FIG. 15, first and second engagement surfaces are provided respectively at the exterior surfaces of the eccentric connecting rod bearing and the interior surface of the bore 70 of the connecting rod 50. These engaging surfaces can be like those previously discussed, such as the surfaces discussed in connection with FIG. 11C. Bearing metal can be applied to the interior surface 422 of the eccentric connecting rod bearing and the exterior surface of the connecting rod receiving pin of a crank shaft can be machined or otherwise surfaced to have a bearing quality.

In the embodiment of FIG. 16, the eccentric connecting rod bearing is dynamically balanced to minimize or eliminate the turning torque arising from the eccentricity when the crank shaft rotates. For example, a balancing flange 424 can be included in the eccentric connecting rod bearing assembly with the flange comprising a counter weight so that the center of gravity of the eccentric connecting rod bearing 424 is aligned with the axis 64. With this construction, typically the only forces that would cause spontaneous turning of the eccentric portion of the bearing 60 would be bearing friction and eccentric torque forces.

In the embodiment of FIG. 17, respective seals, such as spaced apart O-ring seals 430, are provided to seal the space between the respective friction surfaces of the connecting rod coupling portion of the crank 36 and the eccentric connecting rod bearing. A lubricating fluid distribution mechanism can be provided, such as a cavity or recess that is the same as discussed in connection with FIG. 11A. By sealing these interfaces, with lubricant provided and sealed between the interface of these engaged surfaces, the quantity of pressurized lubricating oil otherwise used to lubricate these surfaces can be reduced.

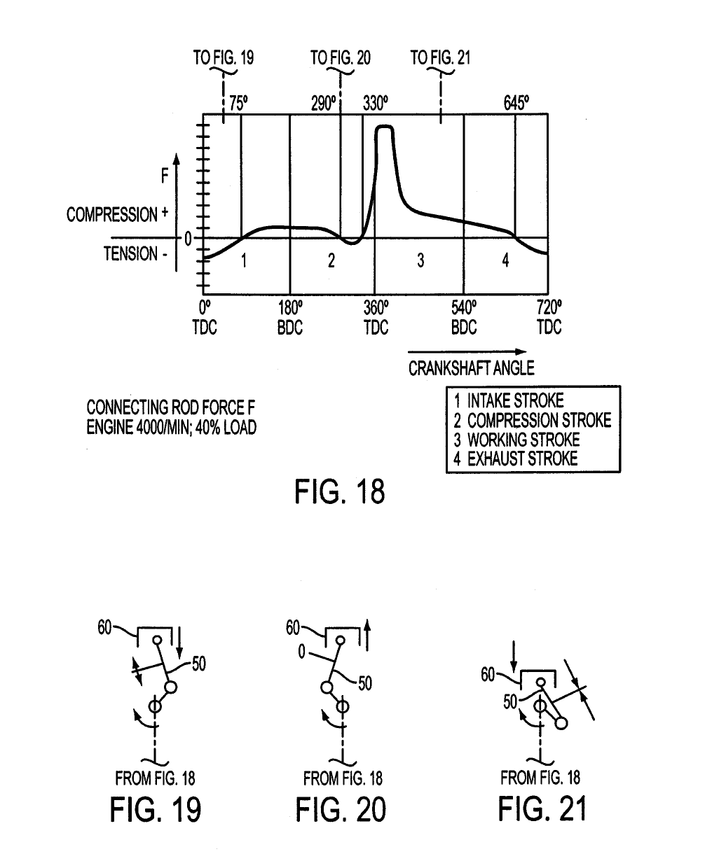

The force in the connection rod 50, at least twice during a working cycle of an engine, passes through a point where it is zero. In the region of the working cycle at the point where the force in the connecting rod passes through zero, the torque required to turn the eccentric portion of the eccentric connecting rod bearing is low. FIGS. 18, 19, 20 and 21 illustrate the changes in forces on the connecting rod during a working cycle (the exhaust stroke not being separately depicted in these figures). In accordance with a desirable embodiment, the eccentric portion of the eccentric crank shaft bearing (and bearings if a plural cylinder engine is being operated) is turned to thereby adjust the compression ratio at or near one of the low load cycle positions of the connecting rod.

Assume that a compression ratio adjustment force is applied to drive member 24 (or drive member 23 if a biasing member is included in drive member 23), and that this occurs at a time when the compression or tension forces on the connecting rod are not sufficiently low. In this case, the drive member 23 or 24 is pivoted through a selected angle and preloads (for example, applies a rotational load to a spring or other biasing member, resulting in torsional energy being stored in the spring or other biasing member as potential energy). The biasing member rotates the eccentric portion 62 of the eccentric connecting rod bearing 60 when the torque requirements for rotating the eccentric portion are low, such as before the top dead center position is reached by the piston or after the top dead center position in the suction cycle. A spring biasing member (which can comprise more than one spring), can be used to provide the rotational force to rotate the eccentric portion 62 of the eccentric connecting rod bearing 62 as desired when the load on the connecting rod is reduced.

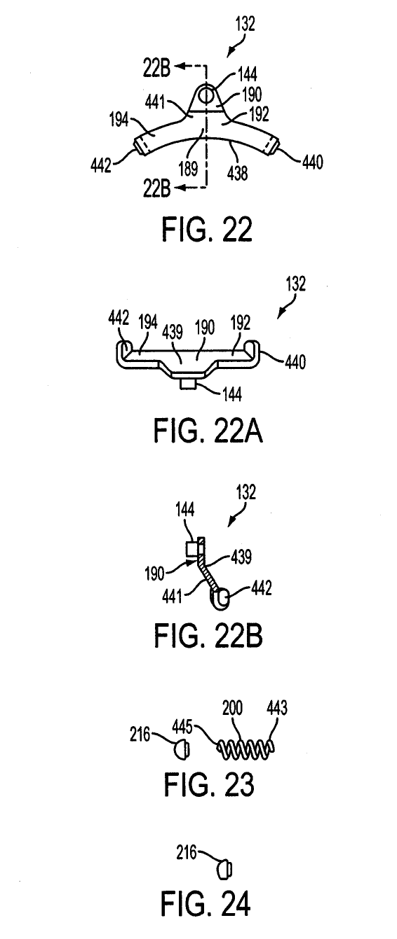

FIGS. 22, 22A and 22B illustrate an exemplary form of link or lever mechanism 132 for coupling the drive member 24 of FIGS. 1 and 3A-3C to the eccentric connecting rod bearing. As previously explained, the illustrated link or lever mechanism comprises a body with a central or intermediate portion 189 and an upwardly extending projecting portion 190 from which an eccentric bearing engaging projection, such as a pin 144, extends or projects. The body also comprises first and second arcuate leg portions 192, 194 extending outwardly from the intermediate portion 189 of the body. A base or lower edge 438 of link 132 in this example is shaped to engage the shelf 254 of the recess 252 (FIG. 4B). One major surface 439 of the link in this example is angled to conform to the contour of angled surface 256 of the recess 252. The major surface 441, opposite to surface 439, is also desirably angled to match the corresponding contour of the surface 260 of cheek portion 80 of the crank shaft (see FIG. 1). The motion of the link is thereby guided by surfaces 256 and 260. The distal end of leg portion 192 comprises a spring engager that can comprise an inwardly turned flange 440. A similar spring engager, such as a flange 442, can be provided at the distal end of leg portion 194. With reference to FIG. 3C and FIGS. 23 and 24, an end portion 443 of coil spring 200 is positioned to engage flange 442 with a stop member 216 engaging the opposite end 445 of the spring 200 when the spring is positioned in a spring receiving cavity (270 in FIG. 4). The stop member 216 can comprise a member of any desirable shape with an exemplary side elevational view of such a stop member being shown in FIG. 24.

With reference to FIGS. 1, 25 and 26, when the compression ratio is being adjusted, the eccentric portion 62 of the eccentric connecting rod bearing 60 (FIG. 1) together with the lower portion 54 of the connecting rod 50 changes the radius of rotation. As a result, the centrifugal forces are changed. Engines with more than one cylinder compensate for this change. However, for single cylinder engines, it is desirable to provide a mass balancing mechanism to offset this change. In addition, such a mass balancing mechanism can also be used in engines having more than one cylinder.

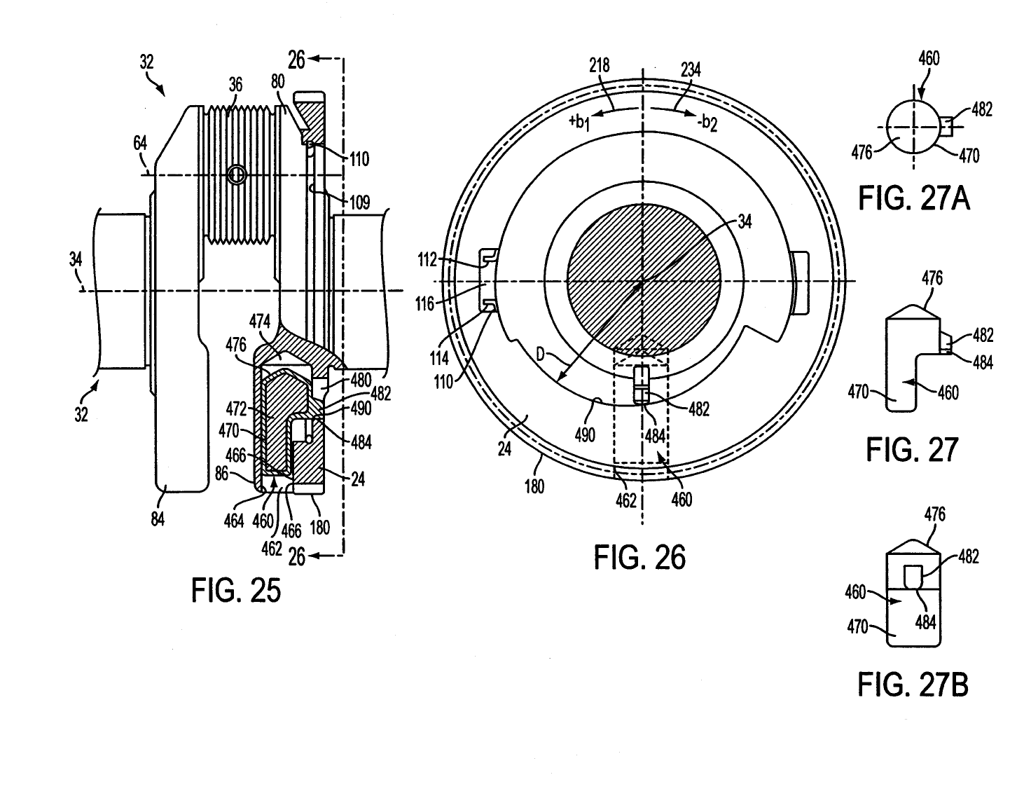

One exemplary form of mass balancing mechanism is illustrated in FIGS. 25 and 26. As can be seen in these figures, a mass balancing weight 460 can be slidably coupled to the crank shaft at a location offset from the connecting rod coupling portion 36 of the crank shaft. As the compression ratio adjuster is operated to shift the eccentric portion of the eccentric connecting rod bearing, the counter balance weight 460 is shifted in a direction such that the weight 460 counterbalances the movement of the eccentric portion 62. As can be best seen in FIG. 26, the mass balancing weight 460 is slidably received in a pocket configured to permit radial inwardly and radial outwardly motion of the weight 460 relative to the crank shaft axis 34. The pocket 462 in this example is formed in the cheek portion 86 of the crank shaft 32 and is bounded in part by a wall 464 within the interior of cheek portion 86 and in part by an interior surface 466 of the drive member 26. The mass balancing weight 460 can be hollow with an outer shell 470 and filled with a relatively heavy material 472, such as lead. The upper end portion of pocket 462, indicated at 474, can be of a concave conical shape with the upper end of the balancing weight 460, indicated at 476, comprising a correspondingly configured convex conical shape. As a result, radially inwardly sliding motion of the weight is accommodated and the strength of the cheek is maintained because the upper end of the pocket is spaced from the exterior of the cheek. The wall 464 and interior portion 466 of drive member 24 guide the inward and outward motion of the weight 460. In addition, a slot or opening 480 is provided in cheek 86 and extends in a radial direction. The weight comprises a position adjustment projection 482 that projects outwardly from the main body portion of the weight in a direction away from the wall surface 464 of the cheek 86. Projection 482 comprises a lower cam engaging surface 484 that is positioned to engage a cam surface 490 provided in the drive member 24. The cam engaging surface 484 can have a convex shape, such as best seen in FIG. 27B, to reduce friction between the cam engaging surface 484 and the cam surface 490.

FIGS. 27, 27A, and 27B illustrate an embodiment of the exemplary mass balancing weight 460 in greater detail.

The operation of this counter balance mechanism will be best understood with reference to FIG. 26 and FIGS. 3A, 3B and 3C. The view in FIG. 26 is opposite to the view shown in FIGS. 3A, 3B and 3C and, for this reason, the directions of the arrows 218, 234 are reversed in FIG. 26 from the directions shown in 3A, 3B and 3C and the ⁻β₂ and ⁺β₂ angles in FIG. 26 are opposite to their locations shown in FIGS. 3A, 3B, and 3C. When the compression ratio is adjusted so as to move the connecting rod outwardly, that is the compression ratio epsilon is being increased, the drive gear 24 moves in the direction of arrow 218. As a result, the projection 482 and surface 484 travel over a portion of the position adjustment cam surface 490 where the distance D from the crank axis 34 to the surface 490 is increasing. Consequently, the weight 460 is allowed to move radially outwardly. Centrifugal force maintains the weight in this radially outwardly shifted direction with projection 484 engaged by the cam surface 490. In contrast, when the compression ratio is adjusted so as to move the connecting rod radially inwardly, that is when epsilon is being decreased, the drive member 24 is moved in the direction indicated by arrow 234 in FIG. 26. In this case, the distance D is decreased so that the position adjuster surface shifts the weight 460 radially inwardly. The curvature of surface 490, which comprises a form of cam, is shaped to shift the weight an amount that maintains the system in balance despite the movement of the eccentric portion of the eccentric connecting rod bearing. It should be noted that, there can be a short delay in shifting the eccentric portion while the connecting rod moves to a position where compression and tension forces on the connecting rod are reduced so that stored potential energy can be used to pivot the eccentric portion. Thus, the weight 460 may be moved prior to the movement of the eccentric. As a practical matter, any such prior movement of the weight 460 has a negligible impact on the operation of the system.

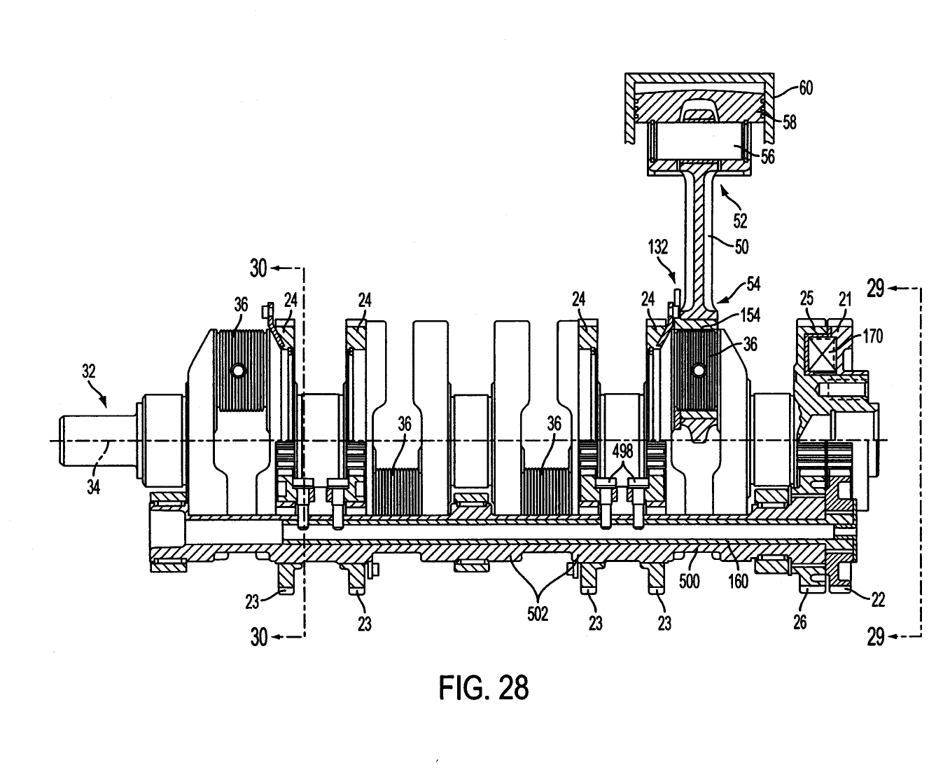

With reference to FIGS. 28, 29 and 30, modern 1, 2, 3 and 4 cylinder engines are typically provided with a balance system to reduce vibration. Such a system typically comprises at least one mass balance shaft with balancing weights and operates with the balancing shaft drivenly coupled to the crank shaft. One commonly known balancing system often is called as a Lanchester drive. Often two such mass balancing drive shafts are utilized with the shafts being positioned at locations parallel to, and respectively above and below the crank shaft, and symmetrically offset the same distance from a vertical plane through the center of the crank shaft.

FIG. 28 illustrates a four cylinder engine with four connecting rod crank shaft coupling portions 36. For convenience, only one connecting rod 50 and associated piston 58 and cylinder 60 is shown. Though not shown, each cylinder in this embodiment would be provided with an associated piston, connecting rod, eccentric bearing, drive member 24, and drive member 23 coupled to the compression adjustment shaft 160. In addition, there are associated interfacing frictional surfaces, such as surfaces that interface at 154 as shown in FIG. 28, provided for each eccentric connecting rod bearing. These surfaces, as previously described, resist uncontrolled or spontaneous relative pivoting of the eccentric connecting rod bearing. In addition, a respective potential energy storing mechanism is desirably provided in association with each eccentric connecting rod bearing for storing potential energy for shifting the eccentric portion of the associated eccentric connecting rod bearing at times when compression and tension forces on the associated connecting rod are reduced.

In the embodiment shown in FIG. 28, fasteners, such as bolts, with two of them being indicated by the number 498 in FIG. 28, can be used to connect the drive members 23 to the compression ratio adjustment shaft 160. In addition, in FIG. 28, a first mass balancing shaft 500 with mass balancing weighted portions or weights, some being indicated by the number 502 in FIG. 28, is provided. The longitudinal axis of shaft 500 is parallel to the axis 34 of the crank shaft 32 and is also parallel to the axis of the compression ratio adjustment shaft 160. In this specific example, the axis of mass balancing shaft 500 is coaxial with the axis of compression ratio adjustment shaft 160. In addition, the mass balancing shaft in this example at least partially surrounds the compression ratio adjustment shaft. Although not required, the coaxial arrangement of the shafts 160, 500 provide benefits. For example, space savings result and the additional weight, cost and friction losses associated with a variable compression ratio system are somewhat shared with the mass balancing shaft. Alternatively, the mass balancing shaft 500 can be separately positioned rather than being combined with the variable compression ratio adjustment shaft.

Mass balancing shafts in the case of 4 cylinder engines are desirably rotated at twice the speed of the crank shaft. In the case of 3 cylinder engines, the balancing shafts are desirably rotated at the same speed as the crank shaft. In FIG. 28, since the engine is a 4 cylinder engine, the compression ratio adjustment shaft 160 and mass balancing shaft 500 are rotated at twice the speed of the crank shaft. Consequently, the drive gears 21 and 22, which drive the compression ratio adjustment shaft 160 in this example, therefore have a ratio of 2 to 1. In this example, Gears 25 and 26 drive the mass balancing shaft and have the same ratio of 2 to 1. The drive gear 23, in this example connected to the shaft 160, drives the drive gear 24 to adjust the eccentric connecting rod bearing as previously explained with a ratio between gear 23 and gear 24 being 1 to 2. In this example, the gear 25 is part of the crank shaft 32. The drive gear 21 can pivot relative to the crank shaft and is coupled to the crank shaft via a compression ratio force generator such as a hydro motor or hydroelectric magnetic motor 170.

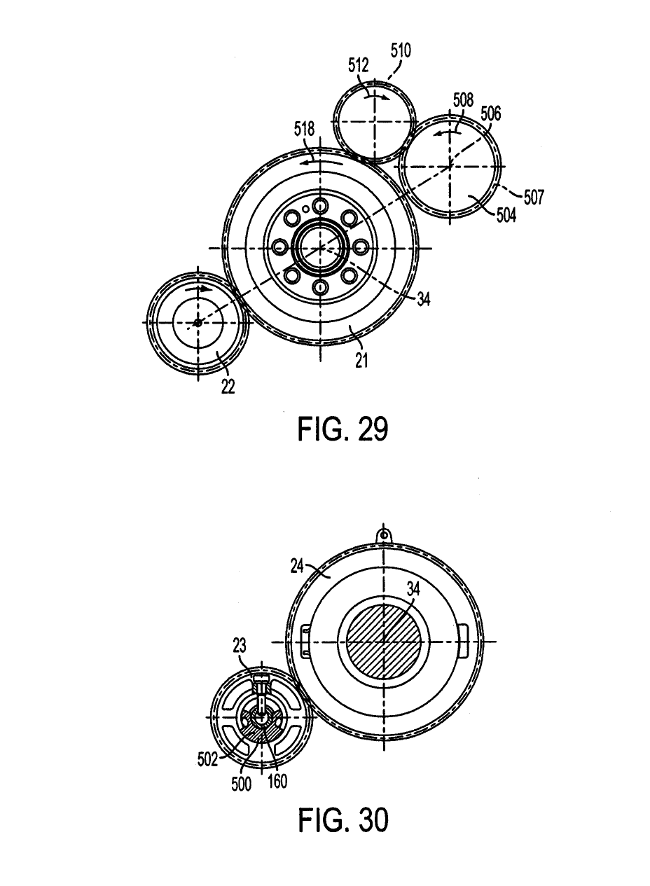

With reference to FIG. 29, a second mass balancing shaft 504 is shown with a longitudinal axis 506 parallel to the crank shaft axis 34. Mass balancing shaft 504 can comprise a gear drive (or alternatively a belt driven, chain drive or otherwise driven) shaft employing a gear 507 rotatable in the direction indicated by arrow 508. The gear 507 is driven by a gear 510 in this example that rotates in a direction indicated by arrow 512. The gear 510 is driven by the gear 25 rotating in the direction of arrow 518. Gear 21 drives the mass balancing shaft 500 via the gear 22.

In FIG. 30, a portion of one of the drive gears 24 is shown together with a portion of a drive gear 23 coupled to the compression ratio adjustment shaft 160. FIG. 30 also shows one of the mass balancing weights 502 included in the mass balancing shaft 500.

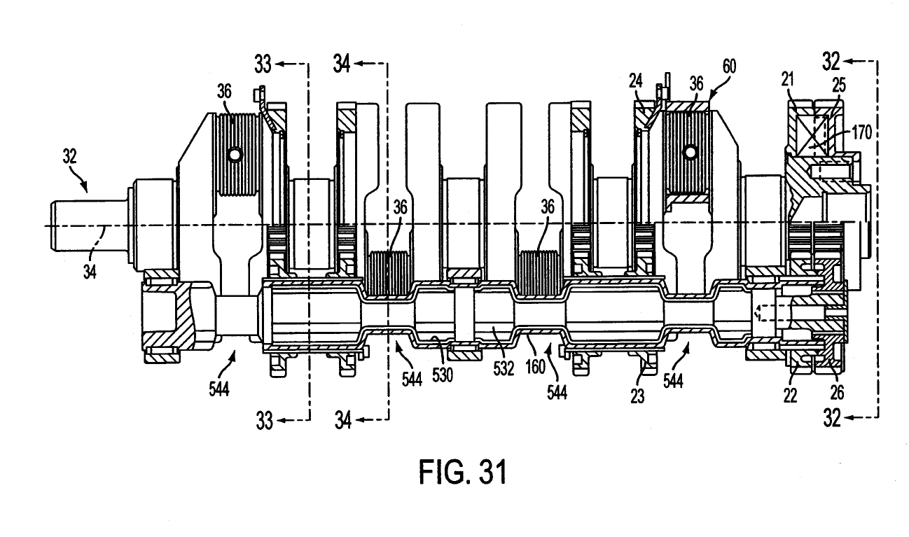

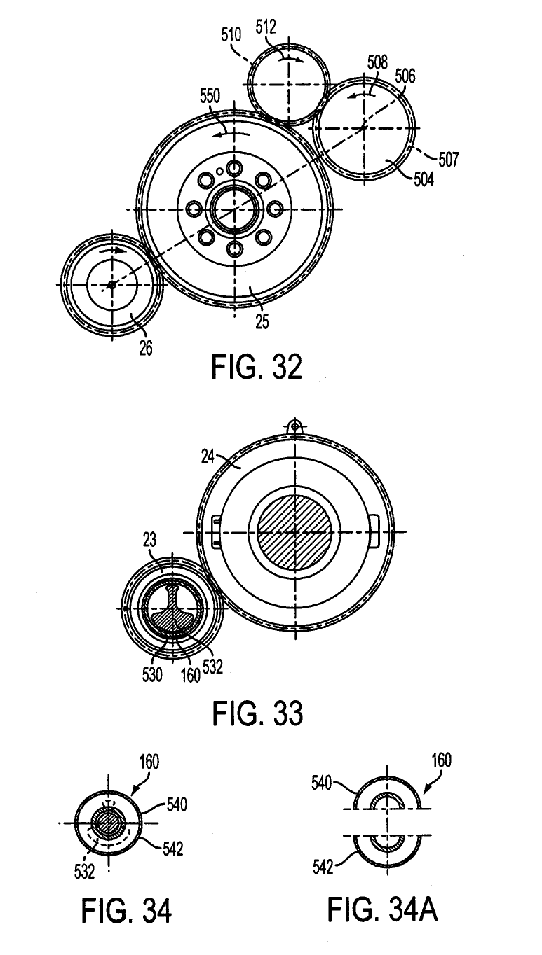

In the embodiment shown in FIGS. 31, 32 and 33, a mass balancing shaft 530 is shown positioned coaxially with, and at least partially within, the compression ratio adjustment shaft 160. The mass balancing shaft comprises balancing weights, with one such weight being indicated at 532 in FIGS. 31 and 33. As can be seen in FIGS. 34 and 34A, for assembly reasons, the compression ratio adjustment shaft 160 can comprise a plurality of longitudinally extending shaft forming sections, such as two half shells 540, 542. Also, as can be seen in FIG. 31, spaced apart bottleneck or areas of reduced cross-sectional dimension 544 are provided in regions of the shafts 160, 530. These bottleneck areas are axially positioned so as to be aligned with the positioning of the respective connecting rod coupling portions 36 of the crank shaft. These bottlenecks provide clearance for the connecting rods as the crank shaft rotates. FIG. 33 is similar to FIG. 30, but illustrates a drive gear 23 with a mass balancing shaft 530 shown interiorly to the compression ratio adjustment shaft 160. One of the mass balancing weights 532 is also shown in FIG. 33. In FIG. 32, a second mass balancing shaft 504 is also shown together with a drive gear 510 operable as previously explained in connection with FIG. 29. The gear 510 is driven by gear 25 rotating in a direction indicated by arrow 550. In addition, gear 25 drives gear 26 which rotates the mass balancing shaft 532. In this embodiment, the shafts 160, 530 need not rotate with exactly the same speed. The mass balancing shaft 530 in this example is driven by gears 25 and 26 at a ratio of 2 to 1. The ratio between gears 21 and 22 can be selected within limits and can differ from a 2 to 1 ratio.

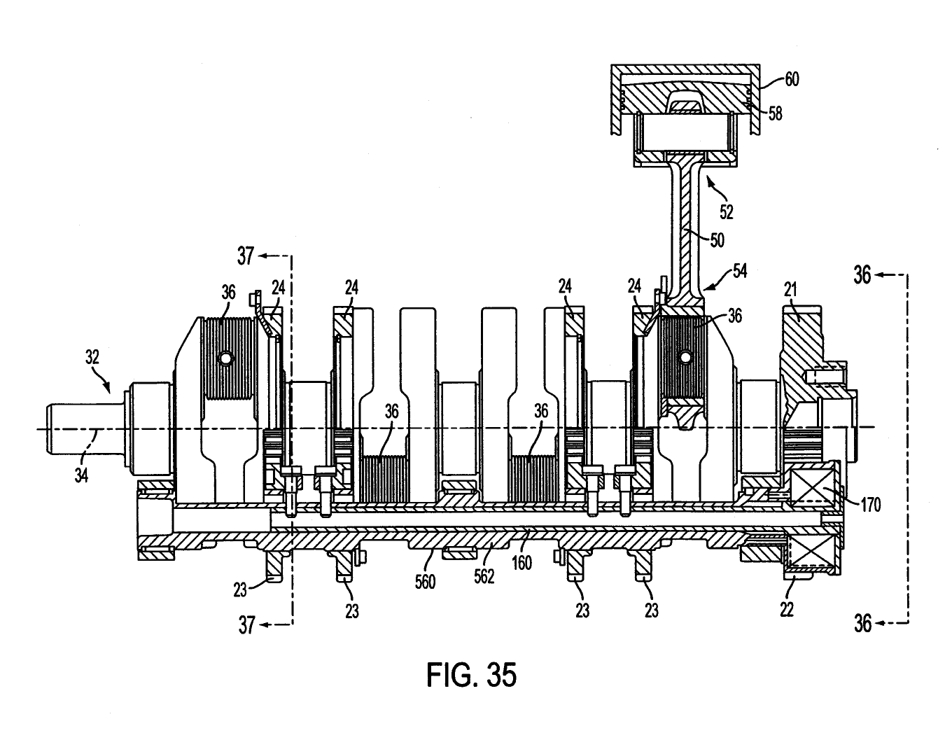

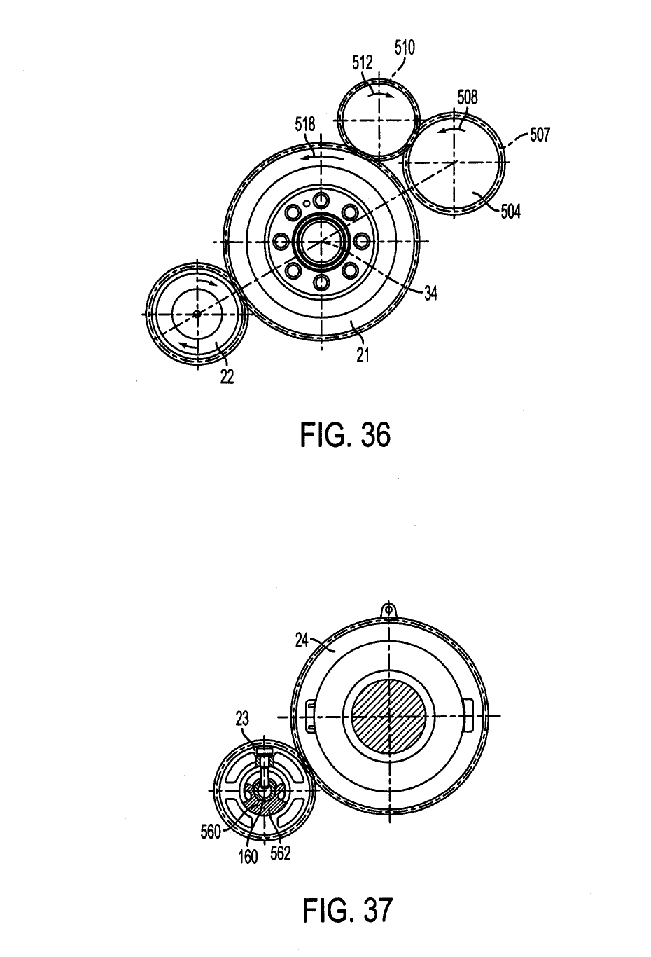

The embodiment of FIG. 35 illustrates an example wherein a mass balance shaft 560 is shown at least partially surrounding a compression ratio adjustment shaft 160. One of the mass balancing weights of mass balance shaft 560 is indicated by the number 562 in FIG. 35. In this embodiment, the compression ratio adjustment force generator 170, such as a hydro motor or electric magnetic motor, is connected to the mass balance shaft and also connects the balance shaft 560 to the compression adjustment shaft 160. In this example, the gear sets 25 and 26 can be eliminated. Alternatively, a structure with a mass balance shaft internal to the compression ratio adjustment shaft, at least in part, can be used with the compression ratio force generator coupling these components together. The respective views shown in FIGS. 36 and 37 taken respectively along the line 36-36 and the line 37-37 in FIG. 35 are like the FIGS. 29 and 30 and for this reason will not be discussed in detail.

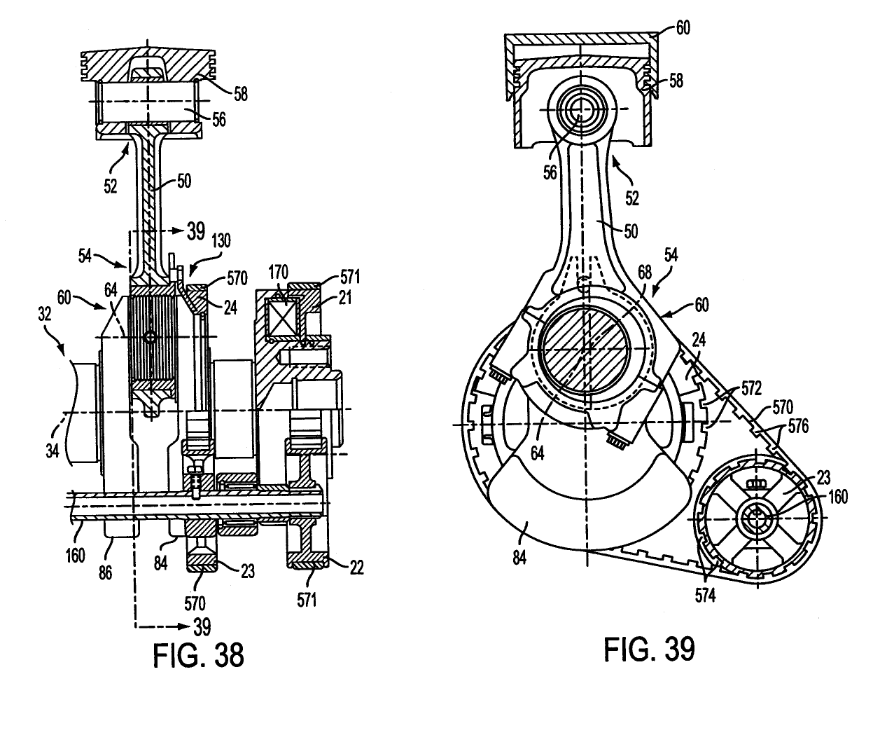

In the embodiment of FIGS. 38 and 39, the drive members 21 and 22 and 23 and 24 are shown in an alternative configuration. Specifically, these drive members comprise belt driven members drivenly coupled together by a drive belt 570 (for drive members 23 and 24) and drive belt 571 (for drive members 21 and 22). The drive belts can comprise a conventional material, such as a convention oil resistant material. As best seen in FIG. 39, the periphery of drive member 24 has a plurality of circumferentially spaced drive belt engaging notches 572. In addition, the periphery of drive member 23 has similar notches 574. The illustrated drive belt 570 comprises a plurality of projections 576 positioned to engage the respective notches of drive members 23, 24 to drivenly interconnect these drive members. Otherwise the operation of the variable compression ratio system of FIGS. 38 and 39 is identical as the system described above in connection with FIGS. 1 and 2.

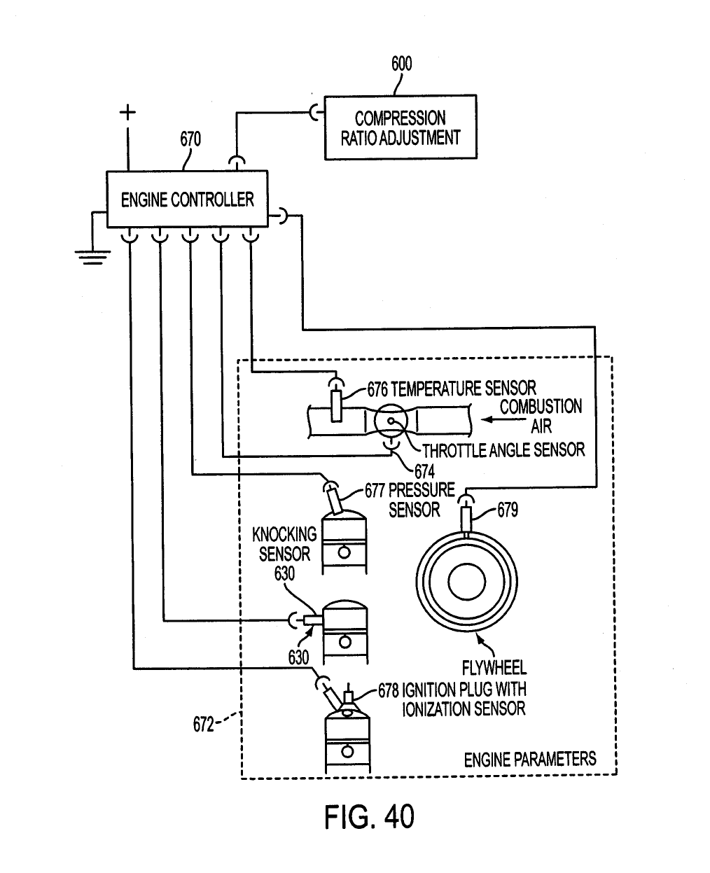

With reference to FIG. 40, an exemplary compression ratio adjuster 600 utilizing an eccentric connecting rod bearing for each connecting rod, such as previously described, is shown for driving the eccentric portion of an eccentric connecting rod bearing to adjust the compression ratio of the engine such as previously described. The compression ratio adjuster 600 comprises a compression adjustment force generator which can be responsive to control signals from an engine controller 670. Engine controller 670 can be a conventional engine controller, such as programmable controller, used in a vehicle which captures various vehicle parameter signals on a system bus utilized in the vehicle. These parameter signals can be used by the engine controller to generate motor control signals should conditions exist where it is desirable to selectively adjust the eccentric portion of eccentric connecting rod bearings to vary the stroke of the associated piston cylinders. These control signals can be responsive to one or more engine operating parameters. Exemplary parameters are indicated within block 672, together with schematic illustrations of sensors for measuring the parameters. For example, a throttle angle sensor 674 can be used to deliver a throttle angle signal via a data bus to the engine controller. The eccentric portion of each eccentric connecting rod bearing can be driven in clockwise or counterclockwise directions in response to control signals from the engine controller 670 in response to the throttle angle sensor signals. For example, under open throttle (full load) conditions, the compression ratio would typically be reduced. Under closed throttle (idle) conditions, the compression ratio would typically be increased. As another example, the combustion air temperature can be sensed by temperature sensor 676. In general, higher combustion air temperatures can be used to produce control signals that reduce the compression ratio. In contrast, lower temperature sensed signals can be used to increase the threshold to produce control signals that increase the compression ratio. As yet another example, a pressure sensor 677 can be used to sense the cylinder head pressure. Above a pre-defined pressure level at a certain crank shaft position, for example the top dead center position, the compression ratio would typically be decreased. Below this pre-determined pressure level, the compression ratio can be increased. The crank shaft position can be sensed by a crank shaft position sensor 679. As a further example, an ionization sensor, typically integrated into an ignition plug, senses in the moment of ignition the grade of the ionization of the air/fuel mixture of the internal combustion engine. Above a pre-determined threshold, the compression ratio typically can be decreased. Below the pre-determined threshold, the compression ratio typically can be increased. An ignition plug with an ionization sensor is indicated at 678 in FIG. 40. As another alternative, a knocking sensor indicated schematically at 680, typically mounted to a cylinder block, senses vibration spikes caused by uncontrolled ignition of the combustion mix, corresponding to the engine knocking. In response to such signals, the engine controller 670 can control the system to decrease the compression ratio. Control signals derived from combinations of sensed engine parameter conditions can also be used.

Having illustrated and described the principles of my invention with reference to a number of embodiments, it should be apparent to those of ordinary skill in the art that the invention may be modified in arrangement and detail without departing from these principles. I claim as my invention all modifications which fall within the scope of the following claims.

I claim:

1. An internal combustion engine comprising:
a crank shaft rotatable about a crank shaft axis and comprising a connecting rod coupling portion defining a first axis;
at least one piston cylinder;
a piston slidably received by said at least one cylinder so as to reciprocate between top dead center and bottom dead center positions within said cylinder;
a connecting rod comprising a piston coupling end portion pivotally coupled to the piston and a crank coupling end portion pivotally coupled to the connecting rod coupling portion of the crank shaft, such that rotation of the crank shaft causes the connecting rod to reciprocate and move the piston between top dead center and bottom dead center positions;
a crank shaft coupler comprising an eccentric portion defining a second axis and operable to couple the connecting rod coupling portion of the crank shaft to the crank coupling end portion of the connecting rod, the eccentric portion being positioned such that pivoting of the crank shaft coupler about the first axis from a first crank shaft coupler position to a second crank shaft coupler position pivots the eccentric portion from a first eccentric position to a second eccentric position and shifts the second axis relative to the crank shaft axis to thereby vary the compression ratio of said at least one piston cylinder;
a compression ratio adjuster comprising a first portion coupled to the crank shaft coupler and pivotable from a first compression ratio adjuster position to a second compression ratio adjuster position in response to a compression ratio adjustment force, the compression ratio adjuster comprising an energy storage member coupled to the first portion of the compression ratio adjuster and to the crank shaft coupler;
pivotal movement of the first portion of the compression ratio adjuster from the first compression ratio adjuster position to the second compression ratio adjustment position loading the energy storage member with potential energy, the potential energy pivoting the crank shaft coupler eccentric portion from the first crank shaft coupler position to the second crank shaft coupler position as the piston approaches or reaches one or more positions where compression and tension forces in the connecting rod are insufficient to resist pivoting of the crank shaft coupler eccentric portion by the potential energy; and
first and second engagement surfaces positioned on or between the connecting rod and the first portion of the compression ratio adjuster and in contact with one another, the first and second engagement surfaces being pivotal relative to one another and providing frictional resistance to pivoting of the eccentric portion in the absence of the compression ratio adjustment force.

2. An internal combustion engine according to claim 1 comprising at least one of (a) the crank shaft coupler being coupled to the connecting rod coupling portion by first and second engagement surfaces that comprise engaging features that permit pivoting of the crank shaft coupler relative to the connecting rod coupling portion while resisting such relative pivoting; (b) the crank shaft coupler being coupled to the crank coupling end portion of the connecting rod by first and second engagement surfaces that comprise engaging features that permit pivoting of the crank shaft coupler relative to the crank coupling end portion of the connecting rod while resisting such relative pivoting; or (c) the compression ratio adjuster being coupled to the crank shaft by first and second engagement surfaces that comprise engaging features that permit pivoting of the compression ratio adjuster relative to the crank shaft coupler while resisting such relative pivoting.

3. An internal combustion engine according to claim 1 wherein the engaging features comprise interfitting threads.

4. An internal combustion engine according to claim 1 wherein the engaging features comprise annular interfitting rings.

5. An internal combustion engine according to claim 2 wherein one of the first and second engagement surfaces are formed on the connecting rod coupling portion of the crank shaft other than by removing material from the crank shaft coupling portion, except for grinding or surfacing of the formed surface features.

6. An internal combustion engine according to claim 5 wherein said one of the first and second features comprise a plurality of annular grooves.

7. An internal combustion engine according to claim 1 wherein the first and second engaging surfaces comprise interfitting substantially V-shaped grooves and interfitting substantially V-shaped ridges, the grooves and ridges having side walls with an angle α there between, and wherein α is selected such that the frictional resistance is greater than the sum of the eccentricity torque and the bearing torque, the bearing torque being the maximum of the torque between the connecting rod and crank shaft coupler and the torque between the crank shaft coupler and the connecting rod coupler.

8. An internal combustion engine according to claim 1 wherein the compression ratio adjuster comprises a compression adjustment shaft that is pivotal about a compression adjustment shaft axis spaced from and parallel to the crank shaft axis, second and third spaced apart drive members mounted to the compression adjustment shaft, a first drive member coupled to the crank shaft and rotatable relative to the crank shaft, the first drive member being drivenly coupled to the second drive member, a fourth drive member coupled to the crank shaft coupler and drivenly coupled to the third drive member, a compression ratio adjustment force generator coupled to the first drive member and operable to pivot the first drive member relative to the crank shaft to thereby apply the compression ratio adjuster adjustment force to the first drive member, from the first drive member to the second drive member, from the second drive member to the compression adjustment shaft, from the compression adjustment shaft to the third drive member and from the third drive member to the fourth drive member, the fourth drive member comprising said first portion of the compression ratio adjuster, the turning of the first and fourth drive members being in the same direction and the turning of the second and third drive members being in the same direction, and the drive ratio of the first drive member to second drive member being the same as the drive ratio of the fourth drive member to the third drive member.

9. An internal combustion engine according to claim 8 wherein the compression ratio adjustment force generator is mounted to the crank shaft and couples the first drive member to the crank shaft.

10. An internal combustion engine according to claim 8 wherein the compression ratio adjustment force generator is mounted to the compression adjustment shaft.

11. An internal combustion engine according to claim 10 comprising a balance shaft coaxial with the compression adjustment shaft, the compression ratio adjustment force generator connecting the balance shaft to the compression adjustment shaft.

12. An internal combustion engine according to claim 9 wherein the compression ratio adjustment force generator comprises a hydro motor or an electromagnetic motor.

13. An internal combustion engine according to claim 10 wherein the compression ratio adjustment force generator comprises a hydro motor or an electromagnetic motor.

14. An internal combustion engine according to claim 1 wherein the crank shaft coupler comprises an eccentric connecting rod bearing comprising a plurality of sections that each define a portion of a bore that receives the connecting rod coupling portion of the crank shaft, the eccentric bearing sections together encircling the connecting rod coupling portion of the crank shaft.

15. An internal combustion engine according to claim 8 in which the first, second, third and fourth drive members comprise respective gears that engage one another.

16. An internal combustion engine according to claim 8 in which the drive ratio of the first drive member to the second drive member is two to one and the drive ratio of the fourth drive member to the third drive member is two to one.

17. An internal combustion engine according to claim 8 in which the compression ratio adjustment force generator comprises a hydro motor.

18. An internal combustion engine according to claim 8 in which the energy storage member comprises at least one first biasing spring and at least one second biasing spring associated with one of the drive members, with said at least one first biasing spring being operable such that said at least one first biasing spring is loaded with the potential energy upon pivoting the associated drive member in a first direction, and with said at least one second biasing spring being operable such that said at least one second biasing spring is loaded with potential energy upon pivoting the associated drive member in a second direction opposite to the first direction.

19. An internal combustion engine according to claim 18 wherein the crank shaft coupler comprises a projecting portion that defines a link pin receiving slot, the compression ratio adjuster comprising a link comprising a base portion and a crank shaft coupler engagement pin projecting from the base portion, the crank shaft coupler engagement pin being slidably and pivotally positioned within said link pin receiving slot, the link comprising first and second arcuate leg portions projecting from the base portion, the first drive member comprising a first arcuate recess portion positioned to receive a portion of the first leg portion, the first drive member also comprising a second arcuate recess portion positioned to receive a portion of the second leg portion, the at least one first biasing spring being coupled to the first leg portion and the at least one second biasing spring being coupled to the second leg portion, the first and second recess portions each comprising a stop against which the respective at least one first and second biasing springs are compressed upon pivoting the fourth drive member in the respective first and second directions to thereby store potential energy in the respective compressed at least one of said first and second biasing springs, the potential energy pivoting the eccentric portion of the crank coupler when compression forces and tension forces in the connecting rod are insufficient to resist pivoting of the crank shaft coupler eccentric portion.

20. An internal combustion engine according to claim 8 wherein at least one of the third and fourth drive members comprises a first drive member portion pivotal relative to a second drive member portion, said at least one of the third and fourth drive members comprising at least one biasing spring coupling the first drive member portion to the second drive member portion, the first drive member portion being pivoted relative to the second drive member portion to store the potential energy in the at least one biasing spring in response to the application of the compression ratio adjuster adjustment force.

21. An internal combustion engine according to claim 1 wherein the crank coupling end portion of the connecting rod comprises a connecting rod bounded by a connecting rod bore surface, the crank shaft connecting rod coupling portion comprises a crank pin portion bounded by an exterior crank pin surface, the crank shaft coupler comprises a crank pin receiving bore bounded by a crank pin receiving bore surface, the crank pin portion being received by the crank pin receiving bore, the crank shaft coupler comprising a crank shaft coupler exterior surface, the crank shaft coupler being received by the connecting rod bore, and wherein the engaging features comprise features on the exterior crank pin surface and features on the crank pin receiving bore surface.

22. An internal combustion engine according to claim 21 comprising first and second spaced apart seals operably positioned to seal pressure oil in the engaging features.

23. An internal combustion engine according to claim 21 comprising a lubricating fluid distribution cavity formed in the crank pin receiving bore surface and at least one lubricating fluid flow opening communicating from the crank shaft coupler exterior surface to the lubricating fluid distribution cavity, the lubricating fluid distribution cavity being positioned such that communication is maintained between at least one lubricating fluid flow opening and the lubricating fluid flow distribution cavity in all positions to which the eccentric portion is pivoted.

24. An internal combustion engine according to claim 21 comprising a bearing positioned between the crank shaft coupler exterior surface and the connecting rod bore surface.

25. An internal combustion engine according to claim 21 wherein one of the crank shaft coupler exterior surface and the connecting rod bore surface has a bearing quality surface and the other of the crank shaft coupler exterior surface and the connecting rod bore surface comprises bearing material.

26. An internal combustion engine according to claim 1 wherein the crank coupling end portion of the connecting rod comprises a connecting rod bounded by a connecting rod bore surface, the crank shaft connecting rod coupling portion comprises a crank pin portion bounded by an exterior crank pin surface, the crank shaft coupler comprises a crank pin receiving bore bounded by a crank pin receiving bore surface, the crank pin portion being received by the crank pin receiving bore, the crank shaft coupler comprising a crank shaft coupler exterior surface, the crank shaft coupler being received by the connecting rod bore, and wherein the crank coupling end portion of the connecting rod comprises a crank receiving bore and wherein the engaging features comprise features on the crank shaft coupler exterior surface and features on the connecting rod bore surface.

27. An internal combustion engine according to claim 26 wherein the crank pin receiving bore surface and the crank shaft coupler exterior surface comprises bearing material and the other of the crank pin receiving bore surface and the crank shaft coupler exterior surface comprises a bearing surface.

28. An internal combustion engine according to claim 1 wherein the crank shaft comprises at least one cheek portion, the first portion of the compression ratio adjuster comprising a drive member pivotally coupled to the cheek portion, the engaging features comprising features on the cheek portion and features on the drive member that engage one another.

29. An internal combustion engine according to claim 28 wherein the drive member comprises an annular drive gear comprising at least two arcuate sections, the arcuate sections comprising interfitting locking features that selectively secure the arcuate sections together to comprise the drive gear.

30. An internal combustion engine according to claim 1 wherein the first portion of the compression ratio adjuster comprises a drive member that is adapted for mounting to the crank shaft.

31. An internal combustion engine according to claim 30 wherein the drive member comprises an annular drive member comprising at least two arcuate sections, the arcuate sections comprising interfitting locking features that selectively secure the arcuate sections together.

32. An internal combustion engine according to claim 30 wherein the crank shaft comprises a threaded annular drive member supporting surface, wherein the drive member comprises a threaded annular crank shaft mounting surface, wherein the drive member crank shaft mounting surface is threadedly mounted to the drive member supporting surface.

33. An internal combustion engine according to claim 32 wherein the drive member comprises an annular drive member comprising at least two arcuate sections, the arcuate sections comprising interfitting locking features that selectively secure the arcuate sections together.

34. An internal combustion engine according to claim 30 wherein the crank shaft comprises a drive member supporting surface with an annular first retention spring receiving groove, wherein the drive member comprises an annular crank shaft mounting surface with an annular second retention spring receiving groove, and a retention spring ring selectively positioned in the first and second retention spring receiving grooves to mount the drive member to the crank shaft.

35. An internal combustion engine according to claim 34 wherein the drive member comprises an annular drive member comprising at least two arcuate sections, the arcuate sections comprising interfitting locking features that selectively secure the arcuate sections together.

36. An internal combustion engine according to claim 1 wherein the crank shaft comprises a drive member support portion, the first portion of the compression ratio adjuster comprises a drive member adapted for pivotal support by the drive member support portion of the crank shaft, the drive member comprising first and second major opposed drive member surfaces, the first drive member surface generally facing toward the crank shaft coupler and the second drive member surface generally facing away from the crank shaft coupler, the second drive member surface comprising a wall engaging surface portion, the engine comprising a drive member engaging wall portion with a wall surface positioned to engage the wall engaging portion to restrict shifting of the drive member away from the crank shaft coupler.

37. An internal combustion engine according to claim 36 wherein the wall engaging surface portion comprises a convex engaging surface positioned to slidably engage the drive member engaging wall portion.

38. An internal combustion engine according to claim 36 wherein the drive member comprises an annular drive member comprising at least two arcuate sections, the arcuate sections comprising interfitting locking features that selectively secure the arcuate sections together.

39. An internal combustion engine according to claim 1 wherein the crank shaft coupler comprises an eccentric connecting rod bearing comprising a counter balance member positioned to counter balance the eccentric portion.

40. An internal combustion engine according to claim 39 wherein the crank shaft coupler comprises a lever portion adapted to engage the first portion.

41. An internal combustion engine according to claim 40 wherein the lever portion comprises a flange defining a slot and wherein the first portion comprises a projection slidably engaging the slot, and wherein a portion of the flange comprises the counter balance member.

42. An internal combustion engine according to claim 8 wherein the fourth drive member comprises a mass balancing weight slidably coupled to the crank shaft, a cam coupled to the fourth drive member and to the mass balancing weight, the cam being configured such that pivoting the compression ratio adjuster to shift the eccentric portion of the crank shaft coupler pivots the fourth drive member and cam in a direction such that the cam shifts the mass balancing weight in a direction that counter balances the movement of the eccentric portion of the crank shaft coupler.

43. An internal combustion engine according to claim 42 wherein the crank shaft comprises a cheek portion, the fourth drive member being pivotally coupled to the cheek portion, the cheek portion defining a cavity that slidably receives the mass balancing weight so as to permit radially outward and radially inward motion of the mass balancing weight toward and away from the crank shaft axis, the mass balancing weight comprising a position adjustment projection extending outwardly from the mass balancing weight and into engagement with the cam such that pivoting the cam in one direction shifts the mass balancing weight radially inwardly and pivoting the cam in a direction opposite to said one direction allows the mass balancing weight to shift radially outwardly, and wherein rotation of the crank shaft urges the mass balance weight radially outwardly.

44. An internal combustion engine according to claim 8 comprising a first mass balancing shaft parallel to the axis of rotation of the crank shaft and coaxial with the compression adjustment shaft, the first mass balancing shaft being drivenly coupled to the crank shaft, and a second mass balancing shaft parallel to the axis of rotation of the crank shaft and drivenly coupled to the crank shaft.

45. An internal combustion engine according to claim 44 wherein the compression adjustment shaft is positioned at least partially within the first mass balancing shaft.

46. An internal combustion engine according to claim 44 wherein the first mass balancing shaft is positioned at least partially within the compression adjustment shaft.

47. An internal combustion engine according to claim 8 wherein there are first and second of said piston cylinders; a respective associated first piston slidably received by the first of said piston cylinders and a respective associated second piston slidably received by the second of said piston cylinders; a respective connecting rod, crank shaft coupler, third drive member and fourth drive member associated with and coupled to said first piston; a respective connecting rod, crank shaft coupler, third drive member and fourth drive member associated with and coupled to the second piston; and a common compression adjustment shaft, common first drive member and common second drive member associated with both of the first and second pistons.

48. An internal combustion engine according to claim 47 wherein there is at least one additional of said piston cylinders, and an associated piston, connecting rod and crank shaft coupler, third drive member and fourth drive members.

49. An internal combustion engine according to claim 1 wherein the compression ratio adjuster is operable to continuously vary the first and second positions within a predetermined limit.

50. An internal combustion engine according to claim 49 wherein the predetermined limit is approximately one hundred and twenty degrees, and wherein the center position of the limit corresponds to the crank shaft coupler being pivoted to a position that aligns the first axis and the second axis in a line parallel to the crank shaft axis.

51. An internal combustion engine comprising:
a crank shaft rotatable about a crank shaft axis and comprising a connecting rod coupling portion defining a first axis;
at least one piston cylinder;
a piston slidably received by said at least one cylinder so as to reciprocate between top dead center and bottom dead center positions within said cylinder;
a connecting rod comprising a piston coupling end portion pivotally coupled to the piston and a crank coupling end portion pivotally coupled to the connecting rod coupling portion of the crank shaft, such that rotation of the crank shaft causes the connecting rod to reciprocate and move the piston between top dead center and bottom dead center positions;
a crank shaft coupler comprising an eccentric portion defining a second axis and operable to couple the connecting rod coupling portion of the crank shaft to the crank coupling end portion of the connecting rod, the eccentric portion being positioned such that pivoting of the crank shaft coupler about the first axis from a first crank shaft coupler position to a second crank shaft coupler position pivots the eccentric portion from a first eccentric position to a second eccentric position and shifts the second axis relative to the crank shaft axis to thereby vary the compression ratio of said at least one piston cylinder;
a compression ratio adjuster comprising a first portion coupled to the crank shaft coupler and pivotable from a first compression ratio adjuster position to a second compression ratio adjuster position in response to a compression ratio adjustment force, the compression ratio adjuster comprising an energy storage member coupled to the first portion of the compression ratio adjuster and to the crank shaft coupler;
pivotal movement of the first portion of the compression ratio adjuster from the first compression ratio adjuster position to the second compression ratio adjustment position loading the energy storage member with potential energy, the potential energy pivoting the crank shaft coupler eccentric portion from the first crank shaft coupler position to the second crank shaft coupler position as the piston approaches or reaches one or more positions where compression and tension forces in the connecting rod are insufficient to resist pivoting of the crank shaft coupler eccentric portion by the potential energy;
first and second engagement surfaces positioned on or between the connecting rod and the first portion of the compression ratio adjuster and in contact with one another, the first and second engagement surfaces being pivotal relative to one another and providing frictional resistance to pivoting of the eccentric portion in the absence of the compression ratio adjustment force;
wherein the compression ratio adjuster comprises a compression adjustment shaft that is pivotal about a compression adjustment shaft axis spaced from and parallel to the crank shaft axis, second and third spaced apart drive members mounted to the compression adjustment shaft, a first drive member coupled to the crank shaft and rotatable relative to the crank shaft, the first drive member being drivenly coupled to the second drive member, a fourth drive member coupled to the crank shaft coupler and drivenly coupled to the third drive member, a compression ratio adjustment force generator coupled to the first drive member and operable to pivot the first drive member relative to the crank shaft to thereby apply the compression ratio adjuster adjustment force to the first drive member, from the first drive member to the second drive member, from the second drive member to the compression adjustment shaft, from the compression adjustment shaft to the third drive member and from the third drive member to the fourth drive member, the fourth drive member comprising said first portion of the compression ratio adjuster, the turning of the first and fourth drive members being in the same direction and the turning of the second and third drive members being in the same direction, and the drive ratio of the first drive member to second drive member being the same as the drive ratio of the fourth drive member to the third drive member;
wherein the first, second, third and fourth drive members comprise respective first and second gears that engage one another and respective third and fourth gears that engage one another, and in which the drive ratio of the first gear to the second gear is two to one and the drive ratio of the fourth gear to the third gear is two to one; and
wherein the crank shaft coupler comprises a projecting portion that defines a link pin receiving slot, the compression ratio adjuster comprising a link comprising a base portion and a crank shaft coupler engagement pin projecting from the base portion, the crank shaft coupler engagement pin being slidably and pivotally positioned within said link pin receiving slot, the link comprising first and second arcuate leg portions projecting from the base portion, the first drive member comprising a first arcuate recess portion positioned to receive a portion of the first leg portion, the first drive member also comprising a second arcuate recess portion positioned to receive a portion of the second leg portion, the at least one first biasing spring being coupled to the first leg portion and the at least one second biasing spring being coupled to the second leg portion, the first and second recess portions each comprising a stop against which the respective at least one first and second biasing springs are compressed upon pivoting the fourth drive member in the respective first and second directions to thereby store potential energy in the respective compressed at least one of said first and second biasing springs, the potential energy pivoting the eccentric portion of the crank coupler when compression forces and tension forces in the connecting rod are insufficient to resist pivoting of the crank shaft coupler eccentric portion.

52. An internal combustion engine according to claim 51 wherein at least one of the third and fourth gears comprises a first drive member portion pivotal relative to a second drive member portion, said at least one of the third and fourth gears comprising at least one biasing spring coupling the first drive member portion to the second drive member portion, the first drive member portion being pivoted relative to the second drive member portion to store the potential energy in the at least one biasing spring in response to the application of the compression ratio adjuster adjustment force.

53. An internal combustion engine according to claim 52 wherein the fourth gear comprises a mass balancing weight slidably coupled to the crank shaft, a cam coupled to the fourth gear and to the mass balancing weight, the cam being configured such that pivoting the compression ratio adjuster to shift the eccentric portion of the crank shaft coupler pivots the fourth gear and cam in a direction such that the cam shifts the mass balancing weight in a direction that counter balances the movement of the eccentric portion of the crank shaft coupler.

54. An internal combustion engine comprising:
a crank shaft rotatable about a crank shaft axis and comprising a connecting rod coupling portion defining a first axis;
at least one piston cylinder;
a piston slidably received by said at least one cylinder so as to reciprocate between top dead center and bottom dead center positions within said cylinder;
a connecting rod comprising a piston coupling end portion pivotally coupled to the piston and a crank coupling end portion pivotally coupled to the connecting rod coupling portion of the crank shaft, such that rotation of the crank shaft causes the connecting rod to reciprocate and move the piston between top dead center and bottom dead center positions;
a crank shaft coupler comprising an eccentric portion defining a second axis and operable to couple the connecting rod coupling portion of the crank shaft to the crank coupling end portion of the connecting rod, the eccentric portion being positioned such that pivoting of the crank shaft coupler about the first axis from a first crank shaft coupler position to a second crank shaft coupler position pivots the eccentric portion from a first eccentric position to a second eccentric position and shifts the second axis relative to the crank shaft axis to thereby vary the compression ratio of said at least one piston cylinder;
a compression ratio adjuster comprising a first portion coupled to the crank shaft coupler and pivotable from a first compression ratio adjuster position to a second compression ratio adjuster position in response to a compression ratio adjustment force, the compression ratio adjuster comprising an energy storage member coupled to the first portion of the compression ratio adjuster and to the crank shaft coupler;
pivotal movement of the first portion of the compression ratio adjuster from the first compression ratio adjuster position to the second compression ratio adjustment position loading the energy storage member with potential energy, the potential energy pivoting the crank shaft coupler eccentric portion from the first crank shaft coupler position to the second crank shaft coupler position as the piston approaches or reaches one or more positions where compression and tension forces in the connecting rod are insufficient to resist pivoting of the crank shaft coupler eccentric portion by the potential energy;
first and second engagement surfaces positioned on or between the connecting rod and the first portion of the compression ratio adjuster and in contact with one another, the first and second engagement surfaces being pivotal relative to one another and providing frictional resistance to pivoting of the eccentric portion in the absence of the compression ratio adjustment force;
wherein the compression ratio adjuster comprises a compression adjustment shaft that is pivotal about a compression adjustment shaft axis spaced from and parallel to the crank shaft axis, second and third spaced apart drive members mounted to the compression adjustment shaft, a first drive member coupled to the crank shaft and rotatable relative to the crank shaft, the first drive member being drivenly coupled to the second drive member, a fourth drive member coupled to the crank shaft coupler and drivenly coupled to the third drive member, a compression ratio adjustment force generator coupled to the first drive member and operable to pivot the first drive member relative to the crank shaft to thereby apply the compression ratio adjuster adjustment force to the first drive member, from the first drive member to the second drive member, from the second drive member to the compression adjustment shaft, from the compression adjustment shaft to the third drive member and from the third drive member to the fourth drive member, the fourth drive member comprising said first portion of the compression ratio adjuster, the turning of the first and fourth drive members being in the same direction and the turning of the second and third drive members being in the same direction, and the drive ratio of the first drive member to second drive member being the same as the drive ratio of the fourth drive member to the third drive member;
wherein the first, second, third and fourth drive members comprise respective gears that engage one another;
wherein the energy storage member comprises at least one first biasing spring and at least one second biasing spring associated with one of the drive members, with said at least one first biasing spring being operable such that said at least one first biasing spring is loaded with the potential energy upon pivoting the associated drive member in a first direction, and with said at least one second biasing spring being operable such that said at least one second biasing spring is loaded with potential energy upon pivoting the associated drive member in a second direction opposite to the first direction;
wherein the crank shaft coupler comprises a projecting portion that defines a link pin receiving slot, the compression ratio adjuster comprising a link comprising a base portion and a crank shaft coupler engagement pin projecting from the base portion, the crank shaft coupler engagement pin being slidably and pivotally positioned within said link pin receiving slot, the link comprising first and second arcuate leg portions projecting from the base portion, the first drive member comprising a first arcuate recess portion positioned to receive a portion of the first leg portion, the first drive member also comprising a second arcuate recess portion positioned to receive a portion of the second leg portion, the at least one first biasing spring being coupled to the first leg portion and the at least one second biasing spring being coupled to the second leg portion, the first and second recess portions each comprising a stop against which the respective at least one first and second biasing springs are compressed upon pivoting the fourth drive member in the respective first and second directions to thereby store potential energy in the respective compressed at least one of said first and second biasing springs, the potential energy pivoting the eccentric portion of the crank coupler when compression forces and tension forces in the connecting rod are insufficient to resist pivoting of the crank shaft coupler eccentric portion;
wherein the fourth drive member comprises a mass balancing weight slidably coupled to the crank shaft, a cam coupled to the fourth drive member and to the mass balancing weight, the cam being configured such that pivoting the compression ratio adjuster to shift the eccentric portion of the crank shaft coupler pivots the fourth drive member and cam in a direction such that the cam shifts the mass balancing weight in a direction that counter balances the movement of the eccentric portion of the crank shaft coupler;
a first mass balancing shaft parallel to the axis of rotation of the crank shaft and coaxial with the compression adjustment shaft, the first mass balancing shaft being drivenly coupled to the crank shaft, and a second mass balancing shaft parallel to the axis of rotation of the crank shaft and drivenly coupled to the crank shaft; and
wherein there are a plurality of piston cylinders, each piston cylinder having a respective associated piston slidably received by the piston cylinder, a respective associated connecting rod, a respective associated crank shaft coupler, a respective associated third drive member and a respective associated fourth drive member, and wherein there is a common compression adjustment shaft, common first drive member and common second drive member associated with all of the pistons.

55. An internal combustion engine according to claim 54 wherein at least one of the third and fourth drive members comprises a first drive member portion pivotal relative to a second drive member portion, said at least one of the third and fourth drive members comprising at least one biasing spring coupling the first drive member portion to the second drive member portion, the first drive member portion being pivoted relative to the second drive member portion to store the potential energy in the at least one biasing spring in response to the application of the compression ratio adjuster adjustment force.

56. An internal combustion engine comprising:
a crank shaft rotatable about a crank shaft axis and comprising a connecting rod coupling portion defining a first axis;
at least one piston cylinder;
a piston slidably received by said at least one cylinder so as to reciprocate between top dead center and bottom dead center positions within said cylinder;
a connecting rod comprising a piston coupling end portion pivotally coupled to the piston and a crank coupling end portion pivotally coupled to the connecting rod coupling portion of the crank shaft, such that rotation of the crank shaft causes the connecting rod to reciprocate and move the piston between top dead center and bottom dead center positions;
a crank shaft coupler comprising an eccentric portion defining a second axis and operable to couple the connecting rod coupling portion of the crank shaft to the crank coupling end portion of the connecting rod, the eccentric portion being positioned such that pivoting of the crank shaft coupler about the first axis from a first crank shaft coupler position to a second crank shaft coupler position pivots the eccentric portion from a first eccentric position to a second eccentric position and shifts the second axis relative to the crank shaft axis to thereby vary the compression ratio of said at least one piston cylinder;
a compression ratio adjuster comprising a first portion coupled to the crank shaft coupler and pivotable from a first compression ratio adjuster position to a second compression ratio adjuster position in response to a compression ratio adjustment force, the compression ratio adjuster comprising an energy storage member coupled to the first portion of the compression ratio adjuster and to the crank shaft coupler;
pivotal movement of the first portion of the compression ratio adjuster from the first compression ratio adjuster position to the second compression ratio adjustment position loading the energy storage member with potential energy, the potential energy pivoting the crank shaft coupler eccentric portion from the first crank shaft coupler position to the second crank shaft coupler position as the piston approaches or reaches one or more positions where compression and tension forces in the connecting rod are insufficient to resist pivoting of the crank shaft coupler eccentric portion by the potential energy; and
means for resisting pivoting of the eccentric portion in the absence of the compression ratio adjustment force.

57. A method of adjusting the compression ratio of an internal combustion engine comprising:
rotating a crank shaft coupled to a piston by a connecting rod to reciprocate a piston within a cylinder between a top dead center position and a bottom dead center position;
turning an eccentric portion of a crank coupler that couples a crank shaft to the connecting rod to adjust the top dead center and bottom dead center positions to adjust the compression ratio;
storing potential energy in response to turning a compression ratio adjuster;
wherein the act of turning the eccentric portion of the crank coupler is performed utilizing the stored potential energy when the piston is in a position away from the bottom dead center portion and to a position wherein the forces on the connecting rod are reduced in comparison to such forces at either of the bottom dead center position or top dead center position.

58. A method according to claim 57 wherein the act of turning the crank shaft coupler comprises utilizing the potential energy to turn the crank shaft coupler at times when forces on a connecting rod coupling the piston to a crank shaft approach or reach a transition from compression forces to tension forces or from tension forces to compression forces.

59. A method according to claim 58 wherein the act of turning the crank shaft coupler comprises at least partially turning the crank shaft coupler after the piston travels away from the bottom dead center position and before the piston reaches the top dead center position.

60. A method of coupling a connecting rod to an eccentric portion of a crank shaft coupler, the connecting rod being coupled to a piston that travels in a piston receiving cylinder between top dead center and bottom dead center positions, the piston rod being coupled by the crank shaft coupler to a crank shaft such that when the crank shaft is driven by an internal combustion engine the piston rod reciprocates and moves the piston in the piston cylinder, the method comprising:
pivoting the crank shaft coupler about a longitudinal axis of a connecting rod bore that receives the crank shaft coupler to rotate the eccentric portion of the crank shaft coupler relative to the connecting rod and adjust the compression ratio; and
coupling at least one of (a) the crank shaft coupler to the connecting rod coupling portion by engaging features that permit pivoting of the crank shaft coupler relative to the connecting rod coupling portion while resisting such relative pivoting; (b) the crank shaft coupler to the crank coupling end portion of the connecting rod by engaging features that permit pivoting of the crank shaft coupler relative to the crank coupling end portion of the connecting rod while resisting such pivoting; or (c) the compression ratio adjuster to the crank shaft by engaging features that permit pivoting of the compression ratio adjuster relative to the crank shaft coupler while resisting such relative pivoting.

61. A method according to claim 60 wherein the act of pivoting comprises storing potential energy and using the potential energy to pivot the crank shaft coupler when tension and compression forces on the connecting rod reach or approach a transition between tension to compression forces or compression to tension forces.

62. A crank shaft for coupling to a connecting rod of an internal combustion engine comprising:
a crank shaft body defining a crank shaft first axis about which the crank shaft is rotatable, the crank shaft comprising at least one crank pin portion for coupling to a connecting rod, the crank pin portion having a second axis parallel to the first axis;
the crank pin portion comprising a substantially right cylindrical exterior surface with surface features thereon, the surface features comprising at least one of threads, annular grooves, and annular rings that extend about the second axis.

63. A crank shaft according to claim 62 wherein the surface features have substantially V-shaped cross sectional shapes with side walls that diverge from one another by an angle α moving away from the second axis.

64. A crank shaft according to claim 63 wherein α is about fifty degrees.

65. A crank shaft according to claim 62 wherein the surface features consist of annular grooves spaced apart along the second axis.

66. A crank shaft according to claim 62 wherein the surface features are formed by forging or pressure rolling.

67. A crank shaft according to claim 62 wherein the surface features are formed other than by removing material from the exterior surface to form the surface features, except for grinding or surfacing of the formed surface features.
